(19) United States
(12) Patent Application Publication
(10) Pub. No.: US 2015/0122741 A1
(43) Pub. Date: May 7, 2015

(54) SYSTEMS AND METHODS FOR TREATING WASTEWATER

(71) Applicant: OriginOil, Inc., Los Angeles, CA (US)

(72) Inventors: Nicholas Eckelberry, Los Angeles, CA (US); William Charneski, Santa Monica, CA (US); Andrew Davies, Los Angeles, CA (US)

(73) Assignee: ORIGINOIL, INC., Los Angeles, CA (US)

(21) Appl. No.: 14/571,652

(22) Filed: Dec. 16, 2014

Related U.S. Application Data
(63) Continuation-in-part of application No. 14/566,819, filed on Dec. 11, 2014.
Application No. 14/566,819 is a continuation-in-part of application No. 14/109,336, filed on Dec. 17, 2013.
Application No. 14/109,336 is a continuation-in-part of application No. 13/942,348, filed on Jul. 15, 2013.
Application No. 13/942,348 is a continuation-in-part of application No. 13/872,044, filed on Apr. 26, 2013.
Application No. 13/872,044 is a continuation-in-part of application No. 13/865,097, filed on Apr. 17, 2013.
Application No. 13/865,097 is a continuation-in-part of application No. 13/753,484, filed on Jan. 29, 2013.
(60) Provisional application No. 61/592,522, filed on Jan. 30, 2012.
(60) Provisional application No. 61/625,463, filed on Apr. 17, 2012.
(60) Provisional application No. 61/649,083, filed on May 18, 2012.
(60) Provisional application No. 61/945,687, filed on Feb. 27, 2014.

(51) Int. Cl. C02F 1/465; C02F 1/461; C02F 1/467; C02F 1/52

(52) U.S. Cl. CPC C02F 1/465; C02F 1/52; C02F 1/46104; C02F 1/4674; C02F 2103/10
USPC 210/704; 210/748.2; 204/272; 210/96.1

(57) ABSTRACT

A system for treating wastewater is disclosed that includes an array of interconnected reactor tubes. Each reactor tube comprises an outer cathode and an inner anode. The inner anode is positioned within the outer cathode. A voltage differential is applied across the inner anodes and the outer cathodes as wastewater flows between the inner anodes and outer cathodes. As the wastewater flows through the reactor tubes, the water is treated. The voltage differential can cause contaminants in the wastewater to flocculate. The flocculated contaminants can then be removed from the wastewater. The voltage differential can also generate chlorine based elements that treat the water removing ammonia and controlling microorganisms. The inner anode and the outer cathode can comprise mixed metal oxide materials or non-donating conductive materials.

### CROSS-REFERENCE TO RELATED APPLICATIONS

This application is a continuation-in-part of U.S. patent application Ser. No. 14/109,336 (Attorney Docket No. 18990.66) filed on Dec. 17, 2013, titled “Removing Compounds from Water Using a Series of Reactor Tubes Containing Cathodes Comprised of Mixed Metal Oxide”, which is a continuation-in-part of U.S. application Ser. No. 14/566,819 (Attorney Docket No. 18990.89) filed on Dec. 11, 2014, titled “Method for Treating Wastewater”, which is a continuation-in-part of U.S. patent application Ser. No. 13/942,348 (Attorney Docket No. 18990.63) filed on Jul. 15, 2013, titled “Removing Ammonia from Water”, which is a continuation-in-part of U.S. patent application Ser. No. 13/872,044 (Attorney Docket No. 18990.62) filed on Apr. 26, 2013, titled “Producing Algae Biomass Having Reduced Concentration Of Contaminants”, which is a continuation-in-part of U.S. patent application Ser. No. 13/865,097 (Attorney Docket No. 18990.60) filed Apr. 17, 2013, titled “Harvesting And Dewatering Algae Using A Two-Stage Process”, which is a continuation-in-part of U.S. patent application Ser. No. 13/753,484 (Attorney Docket No. 18990.58) filed Jan. 29, 2013, titled “Systems And Methods For Harvesting And Dewatering Algae”, which claims priority to U.S. Provisional Patent Application No. 61/592,522 (Attorney Docket No. 18990.44) filed Jan. 30, 2012, titled “Systems And Methods For Harvesting And Dewatering Algae”, which claims priority to U.S. Provisional Patent Application No. 61/625,463 (Attorney Docket No. 18990.47) filed Apr. 17, 2012, titled “Solute Extraction From An Aqueous Medium Using A Modular Device”, and to U.S. Provisional Patent Application No. 61/649,083 (Attorney Docket No. 18990.48) filed May 28, 2012, titled “Modular Systems And Methods For Extracting A Contaminant From A Solution”. This application also claims priority to U.S. Provisional Patent Application No. 61/945,687 (Attorney Docket No. 18990.69) filed Feb. 27, 2014, titled “An Electro-catalytic Process for Coalescing and Skimming Pollutants in Bodies of Water Prior to Filtration”.

The disclosure of each of the applications to which the present application claims priority are incorporated by reference.

### BACKGROUND

Many hydraulic fracturing, oil, gas and other industrial processes result in wastewater that must be treated. For example, hydraulic fracturing operations and oil and gas drilling generate large amounts of wastewater that must be treated. Hydraulic fracturing at a single well can result in the injection of about two million gallons of water and chemicals at a time into a well for a one time “frac job.” A single well may require up to forty or more frac jobs. Oil and gas drilling operations also produce large amounts of wastewater with about eight barrels of wastewater generated for every barrel of oil recovered. Wastewater generated by hydraulic fracturing and oil and gas drilling is highly contaminated with hydrocarbons and drilling chemicals. About at least a third of this wastewater must be disposed of underground or treated. The wastewater is often stored in open pits and then transported to treatment plants. There are a number of concerns associated with treating these types of wastewater including the large amounts of contaminated water generated, limited disposal options, the cost of transporting the wastewater, environmental and regulatory issues, expense and ineffectiveness of chemical treatments, and the need for treatment before the wastewater can be reused.

Industrial processes also result in wastewater that must be treated. Industrial processes such as cooling towers, process water, mill water, and petrochemical processing all generate wastewater that must be treated. For example, industrial wastewater produced from cooling towers can often be contaminated with microorganisms that lead to buildup of these microorganisms in the cooling loop. The buildup of these microorganisms can lead to slime layers and other colonies resulting in odors, inefficient operation of the cooling loop, loss of heat transfer, increased corrosion, and increased consumption of power. There are similar concerns associated with treating these types of wastewater including the large amounts of contaminated water generated, limited disposal and/or treatment options, the cost of transporting the wastewater, environmental and regulatory issues, expense and ineffectiveness of chemical treatments, and the need for treatment before the wastewater can be reused.

### BRIEF SUMMARY

The present disclosure is generally directed to methods and systems for treating wastewater. In some embodiments, the system can comprise a system for treating wastewater from hydraulic fracturing operations, or oil and gas drilling. In other embodiments, the system can comprise a reactor tube. The reactor tube can comprise an outer cathode and an inner anode. The inner anode can be positioned centrally within the outer cathode such that a spacing exists between an outer surface of the inner anode and an inner surface of the outer cathode. A pump can be connected to an input of the reactor tube with the pump receiving wastewater and pumping wastewater into and through the reactor tube such that the wastewater flows between the inner anodes and the outer cathodes and exits through an output. A tank can be connected to the output of the reactor tube with the tank comprising a plurality of tank electrodes configured to generate gas bubbles. A voltage differential can be applied across the outer cathode and the inner anode thereby causing contaminants in the wastewater to flocculate. The gas bubbles can then entrain the flocculated contaminants to a surface of the tank.

In other embodiments, the system can comprise a system for treating wastewater from hydraulic fracturing operations or oil and gas drilling. The system can comprising an array of reactor tubes with each reactor tube comprising an outer cathode and an inner anode and the inner anode being positioned centrally within the outer cathode such that a spacing exists between an outer surface of the inner anode and an inner surface of the outer cathode. The inner anode can comprise a non-donating material. A pump can be connected to an input of the array with the pump receiving influent wastewater and pumping influent wastewater into and through the series of reactor tubes such that the wastewater flows between the inner anodes and the outer cathodes. An injector can be connected to an input of the pump with the injector configured to add hypochlorite or chloride salts to the influent wastewater. A power supply can be included to supply a voltage differential across the inner anodes and outer cathodes to generate chlorine based elements from the hypochlorite or chloride salts within the wastewater, with the chlorine based elements treating the wastewater. A feedback path can be included to divert a portion of the wastewater with chlorine based elements back to an input of the pump such that the chlorine based elements are mixed with influent wastewater to increase the level of chlorine based elements available in the influent wastewater. An oxidative reduction potential meter configured to measure the oxidative reduction potential of the treated wastewater can also be included. The meter can be configured to output a signal for controlling one or more of an amount of hypochlorite added to the influent wastewater, an amount of chloride salts added to the influent wastewater, a rate at which the pump pumps wastewater through the reactor tubes, a voltage level applied by the power supply, or an amount of wastewater that is diverted back through the feedback path.

In yet other embodiments, the present application discloses methods for treating industrial wastewater. The methods can comprise providing industrial wastewater from cooling operations; providing an array of interconnected reactor tubes, each reactor tube comprising an outer cathode and an inner anode being positioned centrally within the outer cathode such that a spacing exists between the outer surface of the anode and the inner surface of the cathode, at least one of the inner anodes comprising a non-donating conductive material; injecting hypochlorite or chloride salts into the wastewater; pumping wastewater with the hypochlorite or the chloride salts into and through the array such that the wastewater flows between the inner anodes and the outer cathodes; applying a voltage differential to the anode and cathode of each reactor tube to generate chlorine based elements from the hypochlorite or the chloride salts, the chlorine based elements treating the wastewater to generate treated water; and diverting a portion of the treated water to an input of the array such that chlorine based elements contained in the treated water are supplied into the wastewater that is pumped into the array.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1A-1B illustrate embodiments of electrodes;

FIGS. 2A-2D illustrate embodiments of electrode configurations;

FIG. 3A illustrates a cross-sectional front view of embodiments of a reactor tube containing an inner electrode sheathed by an outer electrode;

FIG. 3B illustrates a cross-sectional side view of embodiments of a reactor tube;

FIG. 4A illustrates a cross-sectional front view of embodiments of a reactor tube containing an inner electrode sheathed by an outer electrode with apertures;

FIG. 4B illustrates a cross-sectional side view of embodiments of a reactor tube containing an inner electrode sheathed by an outer electrode with apertures;

FIG. 5 illustrates a perspective view of embodiments of a reactor tube containing an inner electrode sheathed by an outer electrode with apertures;

FIG. 6 illustrates embodiments of a two-stage flocculation and flotation system for treating wastewater;

FIGS. 7A-7D illustrate embodiments of a two-stage flocculation and flotation system as the system treats wastewater;

FIG. 8 illustrates embodiments of a system for treating wastewater;

FIG. 9 illustrates a graph of a breakpoint chlorination process;

FIG. 10 illustrates embodiments of a system for treating water by generating chlorine based elements;

FIG. 11 illustrates embodiments of a flow-splitting valve used to provide a feedback path for diverting wastewater with chlorine based elements to be mixed with influent wastewater;

FIG. 12 illustrates embodiments of a reactor tube array;

FIG. 13 illustrates embodiments of a single-stage system for treating wastewater;

FIG. 14 illustrates embodiments of a double unit, single-stage system for treating wastewater;

FIG. 15 illustrates embodiments of a system for treating wastewater;

FIGS. 16A and 16B illustrate embodiments of systems for treating wastewater from hydraulic fracturing operations;

FIGS. 17A and 17B illustrate embodiments of systems for treating wastewater from oil and gas operations; and

FIG. 18 illustrates embodiments of a system for treating industrial wastewater.

### DETAILED DESCRIPTION

In U.S. patent application Ser. Nos. 13/753,484, 13/865,097, and 13/872,044, to which this application claims priority, embodiments were disclosed for a two-stage approach for harvesting algae. This two-stage approach includes a first stage flocculation tank which employs electrodes. In the prior application Ser. No. 13/942,348, reactor tubes similar to the flocculation tank described in Ser. Nos. 13/872,044 and 13/865,097 are employed in series to generate hypochlorite for breaking down ammonia in wastewater flowed through the reactor tubes.

Furthermore in U.S. patent application Ser. Nos. 13/942,348, 13/872,044, 13/865,097, and 14/109,336, to which this application claims priority, embodiments were disclosed for removing ammonia from wastewater using electrodes made of a titanium ruthenium alloy or mixed metal oxide anodes (e.g. titanium core anodes having a coating of a metal in the platinum family such as ruthenium or iridium).

The present application discloses methods and systems for treating wastewater that build on the disclosures of the above referenced prior applications. First, methods and systems for treating wastewater are described herein beginning with embodiments of electrode assemblies including comprising materials and embodiments of configurations. Next, embodiments of configurations of systems that can utilize the disclosed electrode assemblies are disclosed. Lastly, embodiments of systems that integrate configurations of systems that can utilize the disclosed electrode assemblies within systems and methods to treat various types of hydraulic fracturing, oil and gas, and industrial wastewater are disclosed.

Electrode Assemblies

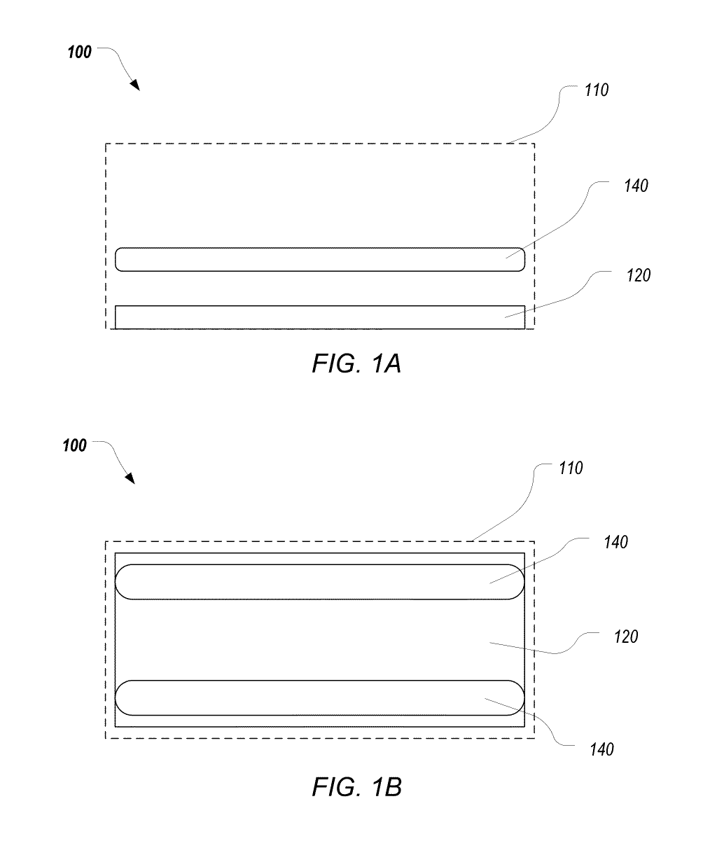

FIGS. 1A and 1B illustrate embodiments of electrode system 100 as disclosed in prior application Ser. No. 13/753,484. The electrode system 100 comprises a tank 110 that can be configured to enclose the electrodes and to contain wastewater. FIG. 1A illustrates a side view while FIG. 1B illustrates a top view of tank 110. The wastewater can be enclosed in tank 110 where it can be brought into contact with a bottom plate electrode 120 and an electrode rod 140. In some embodiments more than one plate electrode may be used. In other embodiments, more than one electrode rod may be used. A voltage differential can be applied between the plate electrode 120 and the electrode rod 140 to generate a current in the wastewater. In other embodiments, a voltage differential can be applied between the plate electrode 120 and the electrode rod 140 to activate electrolysis and/or the generation of gases. In some embodiments, the wastewater contacts the electrodes 120, 140 as it flows through the tank 110. In other embodiments, the wastewater fills the tank 110 and a pump or other similar device circulates the wastewater through the tank 110 so that the wastewater contacts the electrodes 120, 140.

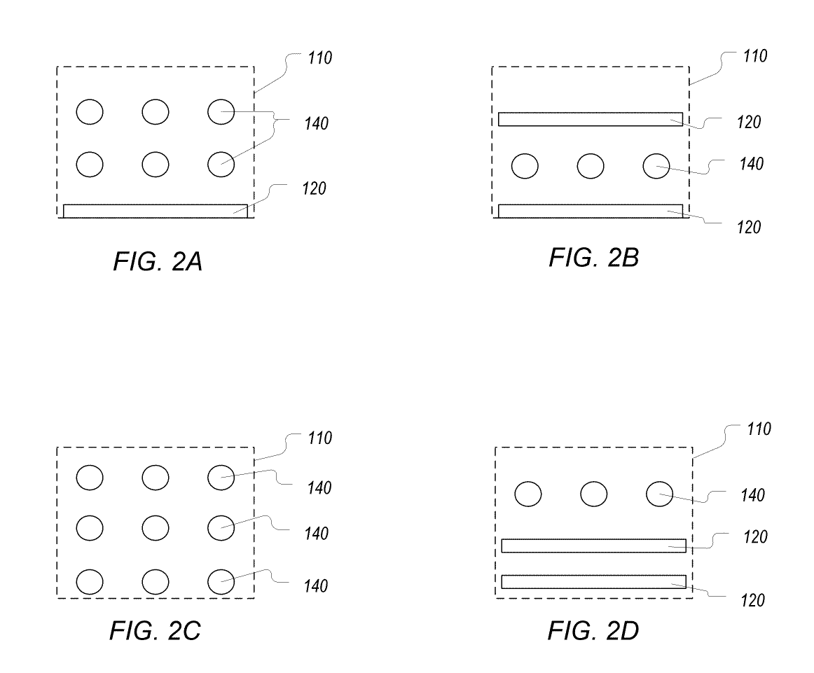

FIGS. 2A to 2D illustrates side cutaway views of embodiments of other configurations of the electrode system 100. FIG. 2A shows a side view of embodiments of other configurations of the electrode system 100 with a plate electrode 120 arranged on the bottom of the tank 110 and multiple rows of electrode rods 140 arranged above the plate electrode 120. FIG. 2B shows a side view of embodiments of other configurations of the electrode system 100 with a plate electrode 120 arranged on the bottom of the tank 110, a row of electrode rods 140 arranged above the plate electrode 120, and a plate electrode 120 arranged above the row of electrode rods 140. FIG. 2C shows a side view of embodiments of other configurations of the electrode system 100 with multiple rows of electrode rods 140 arranged throughout the tank 110. FIG. 2D shows a side view of embodiments of other configurations of the electrode system 100 with a first plate electrode 120 arranged on the bottom of the tank 110, a second plate electrode 120 arranged above the first plate electrode 120, and a row of electrode rods 140 arranged above the plate electrode 120. In other embodiments, the electrode system 100 comprises two or more plate electrodes 120 and no electrode rods 140. In yet other embodiments, the electrode assembly 100 comprises alternating layers of plate electrodes 120 and electrode rods 140. In some embodiments, the electrode rods 140 are hollow. In other embodiments, the electrode rods 140 comprise apertures. In yet other embodiments, the electrode rods 140 are hollow and comprise apertures. In some embodiments, the plate electrodes 120 comprise apertures.

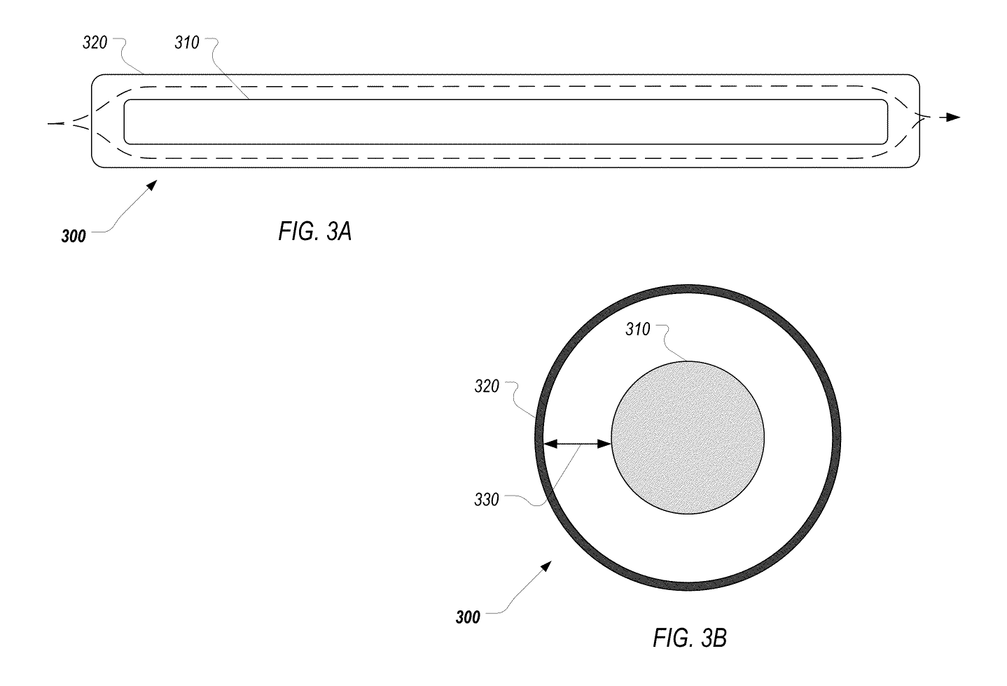

FIGS. 3A and 3B illustrate embodiments of reactor tube 300 as disclosed in prior application Ser. No. 13/865,097. FIG. 3A illustrates a side view of embodiments of a reactor tube 300. The reactor tube 300 can comprise an inner electrode 310 configured to be sheathed by an outer electrode 320. The outer electrode 320 can be configured as an enclosed pipe or tube. The inner electrode 310 can be configured as a solid rod or an enclosed pipe or other cylindrical shape that is contained within the outer cylinder. Accordingly, the wastewater can flow between inner electrode 310 and outer electrode 320. The inner electrode 310 and the outer electrode 320 can be configured as other shapes as long as some type of fluid pathway is formed between the two components. In some embodiments, the surface(s) that contact the wastewater of the inner electrode 310 and/or the outer cathode 320 can include grooves, rifling, ridges, bumps, or other structures to decrease the occurrence of build-up on the surfaces and or to increase vortexing flow of the wastewater through the reactor tube 300.

FIG. 3B illustrates a cross-sectional side view of the reactor tube 300. As shown, a spacing 330 exists between the inner electrode 310 and the outer electrode 320 through which the wastewater flows. In some embodiments, this spacing 330 can be between about 0.5 mm and about 200 mm. In other embodiments, the spacing 330 can be between about 1 mm and about 9 mm. As a voltage differential is applied between the inner electrode 310 and the outer electrode 320, the electrical current can pass through the wastewater and reactions such as flocculation, hydrolysis, and electrolysis can occur.

In some embodiments the inner electrode 310 is configured as an anode and the outer electrode 320 is configured as a cathode. In another embodiment, the inner electrode 310 is configured as a cathode and the outer electrode 320 is configured as an anode.

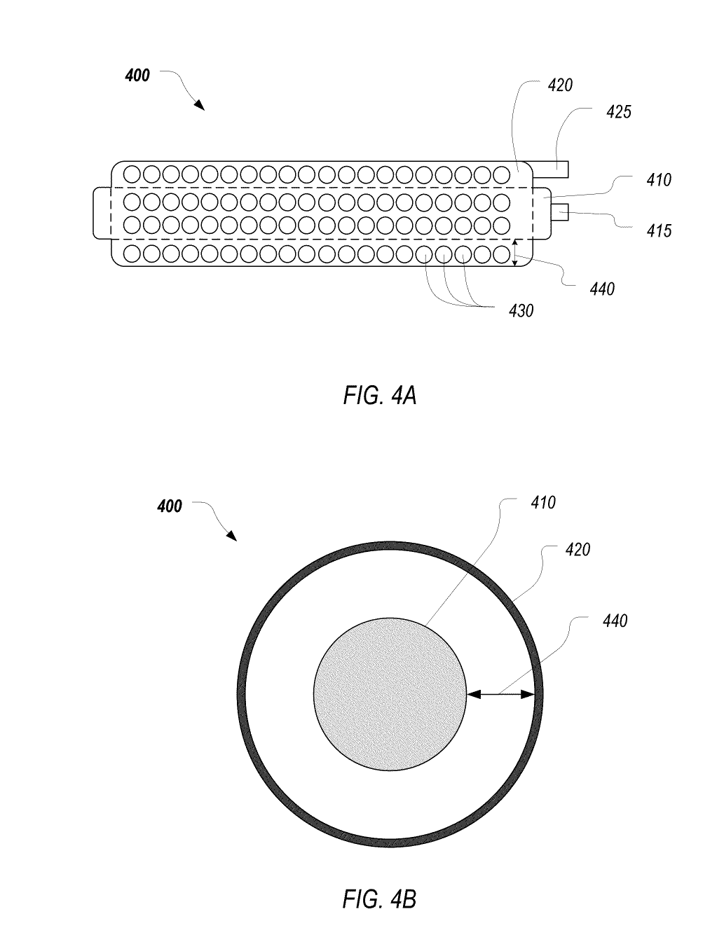

FIGS. 4A and 4B illustrate side and cross-sectional views of embodiments of an electrode assembly 400. As shown in FIG. 4A, some embodiments of the electrode assembly 400 can comprise an inner electrode 410 and an outer electrode 420. The outer electrode 420 can be configured to sheath the inner electrode 410. The outer electrode 420 can comprise a plurality of apertures 430. The inner electrode 410 and the outer electrode 420 can be configured such that a spacing 440 is maintained between the inner electrode 410 and the outer electrode 420. The inner electrode 410 can further comprise an inner electrode connector 415 configured to be connected to a power supply. The outer electrode 420 can further comprise an outer electrode connector 425 configured to be connected to a power supply. FIG. 4B shows a cross-sectional view of some embodiments of the electrode assembly 400. Cross-sectional views of the inner electrode 410, the outer electrode 420, and the spacing 440 are shown.

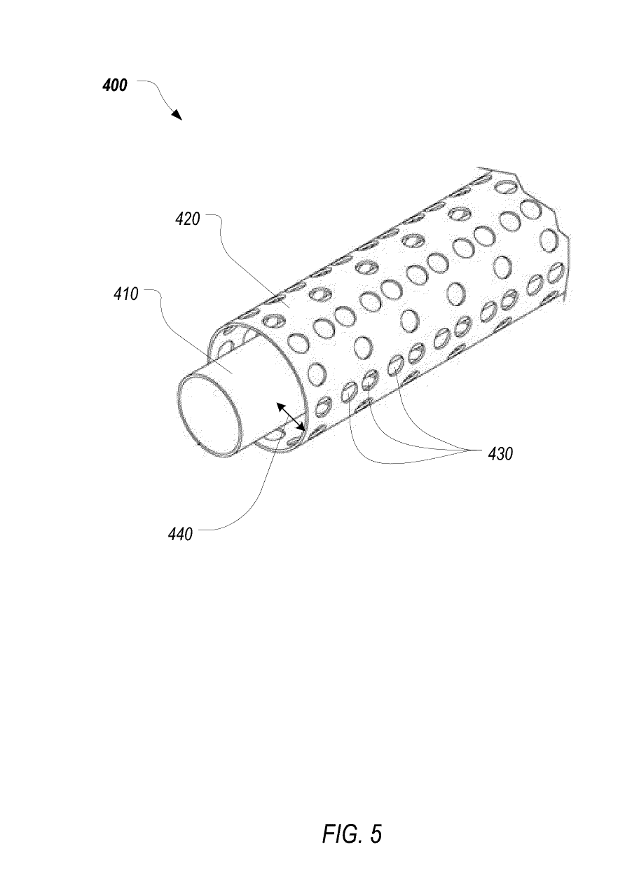

FIG. 5 illustrates a perspective view of some embodiments of an example electrode assembly 400. The inner electrode 410, the outer electrode 420, plurality of apertures 430 and the spacing 440 are shown.

In some embodiments, the spacing 440 can range from about 0.05 mm to about 15 mm. In other embodiments, the spacing 440 can range from about 0.1 mm to about 12 mm. In alternate embodiments, the spacing 440 can range from about 0.1 mm to about 10 mm. In yet other embodiments, the spacing 440 can range from about 1 mm to about 5 mm

In other embodiments, the inner electrode 410 and the outer electrode 420 can be configured with a nested cylinder arrangement, with the inner electrode 410 configured as a cylinder that is centrally positioned within the outer electrode 420, the outer electrode 420 also configured as a cylinder. In some embodiments, the inner electrode 410 can be configured as a rectangular solid with a cross-sectional shape of a square and with the outer electrode 420 similarly configured. In other embodiments, the inner electrode 410 and the outer electrode 420 can be configured as a solid shape with a trapezoidal cross-section. In yet another embodiment, the inner electrode 410 can be configured as a plurality of electrodes that are sheathed by the outer electrode 420. In some embodiments, the inner electrode 410 may not be centrally positioned within the outer electrode 420. In other embodiments, the inner electrode 410 can be configured as an elongated flat sheet. In another embodiment, the inner electrode 410 can be configured as a curved sheet. In other embodiments, the inner electrode 410 can be configured as a cylinder with an ellipsoid cross-section.

In some embodiments the inner electrode 410 can configured as an anode and the outer electrode 420 can be configured as a cathode. In another embodiment, the inner electrode 410 can be configured as a cathode and the outer electrode 420 can be configured as an anode.

In some embodiments, the apertures 430 comprise circular cutouts in the outer electrode 420. In other embodiments, the apertures 430 comprise cutouts of other shapes. In other embodiments, the apertures 430 are configured in size and density to avoid dead zones and allow for release of gas at certain voltages, amperages, and currents. In another embodiment, the apertures 430 may be configured as a mesh, screen, or braided arrangement. In yet other embodiments, the outer electrode 420 and the apertures 430 can be configured as a welded wire mesh, a woven wire mesh, a coated wired mesh, a cage mesh, a wire cloth mesh, and/or a hexagonal netting mesh. In alternate embodiments, the outer electrode 420 and the apertures 430 can be configured as expanded metal, flattened expanded metal, hexagonal expanded metal, square expanded metal, micro expanded metal, and/or ribbon mesh expanded metal.

In some embodiments, the electrode assembly 400 can be configured to be housed within a flow cell that can be configured to allow wastewater to contact and flow through the electrode assembly 400. In other embodiments, the flow cell can then be incorporated into any of the embodiments of this application. In yet other embodiments, the electrode assembly 400 can be configured to be directly in contact with the wastewater. In some embodiments, the electrode assembly 400 can be assembled as an array and configured as part of a flow cell or configured to be directly in contact with the wastewater.

In some embodiments, both the inner electrode 410 and the outer electrode 420 can be configured with a nested cylinder arrangement. The inner electrode 410 can configured as an anode and can comprise a non-donating conductive material. This non-donating conductive material can comprise a noble metal such as platinum, ruthenium, rhodium, palladium, osmium, iridium, or combinations thereof. The outer electrode 420 can be configured as a cathode and can comprise stainless steel or similar material. The apertures 430 can comprise a pattern of round holes in the outer electrode 420. The spacing 440 may range from about 1 mm to about 9 mm.

In some embodiments, any of the electrodes of the electrode assemblies 100, 300, 400 may comprise metal, composite, or other material known to impart conductivity, such as, but not limited to silver, copper, gold, aluminum, zinc, nickel, brass, bronze, iron, lead, platinum group metals, steel, stainless steel, carbon allotropes, and/or combinations thereof. Non-limiting examples of conductive carbon allotropes can include graphite, graphene, synthetic graphite, carbon fiber (iron reinforced), nano-carbon structures, and other forms of deposited carbon on silicon substrates. In some configurations, the anode and/or the cathode can serve as a sacrificial electrode which is used in the flocculation and/or bubble generation processes. As such, electrodes can include consumable conductive metals, such as iron or aluminum.

In some embodiments, the electrodes can be comprised of a catalyst-coated metal such as iridium oxide coated titanium. Such metals can enhance the efficiency of certain processes. For example, by using iridium oxide coated titanium on the anode, the creation of gas bubbles can be facilitated.

In some embodiments, any of the electrodes of the electrode assemblies 100, 300, 400 may comprise a solid support substrate core coated with a non-donating material. In other embodiments, any of the electrodes may comprise a hollow support substrate core coated with a non-donating material. In some embodiments, the electrode configured as an anode can comprise an anode material. In other embodiments, the electrode configured as a cathode can comprise a cathode material.

In some embodiments, the anode material can comprise carbon, aluminum, copper, and platinum group metals. In other embodiments the cathode material can comprise carbon, aluminum, copper, and platinum group metals.

In some embodiments, any of the electrodes of the electrode assemblies 100, 300, 400 may comprise a mixed metal oxide (MMO). MMOs are compounds composed of oxygen atoms bound to transition metals. MMOs have a wide variety of surface structures which affect the surface energy of these compounds and influence their chemical properties. The relative acidity and basicity of the atoms present on the surface of metal oxides can also be affected by the coordination of the metal cation and oxygen anion, which alter the catalytic properties of these compounds. In some embodiments, the blend of MMOs can be a blend of the six platinum group metals layered onto a titanium core. These metals include ruthenium, rhodium, palladium, osmium, iridium, and platinum. A particular blend of metals can be created for a desired result. For example a weighted blend of ruthenium will generate a plurality of protons whereas weighing the blend towards iridium will generate a plurality of hydroxyls.

In some embodiments, the anode material can comprise a non-donating conductive material such as a noble metal including platinum, ruthenium, rhodium, palladium, osmium, iridium, or combinations thereof. In other embodiments, the anode material may comprise materials such as titanium. In alternate embodiments, the anode material may comprise carbon or conductive plastics such as polyethyne. In yet other embodiments, the anode material may comprise any donating metal sufficient to promote electrolysis. In some embodiments, the anode material may comprise a ceramic coated with and/or embedded with a non-donating conductive material.

In some embodiments, the cathode material can comprise a non-donating conductive material such as a noble metal, including platinum, ruthenium, rhodium, palladium, osmium, iridium, or combinations thereof. In other embodiments, the cathode material can comprise stainless steel. In yet other embodiments, the cathode material may comprise any donating metal sufficient to promote electrolysis. In another embodiment, the cathode material can comprise carbon or a conductive plastic such as polyethyne. In some embodiments, the cathode material may comprise a ceramic coated with and/or embedded with a non-donating conductive material.

Two-Stage Flocculation and Flotation System for Treating Wastewater.

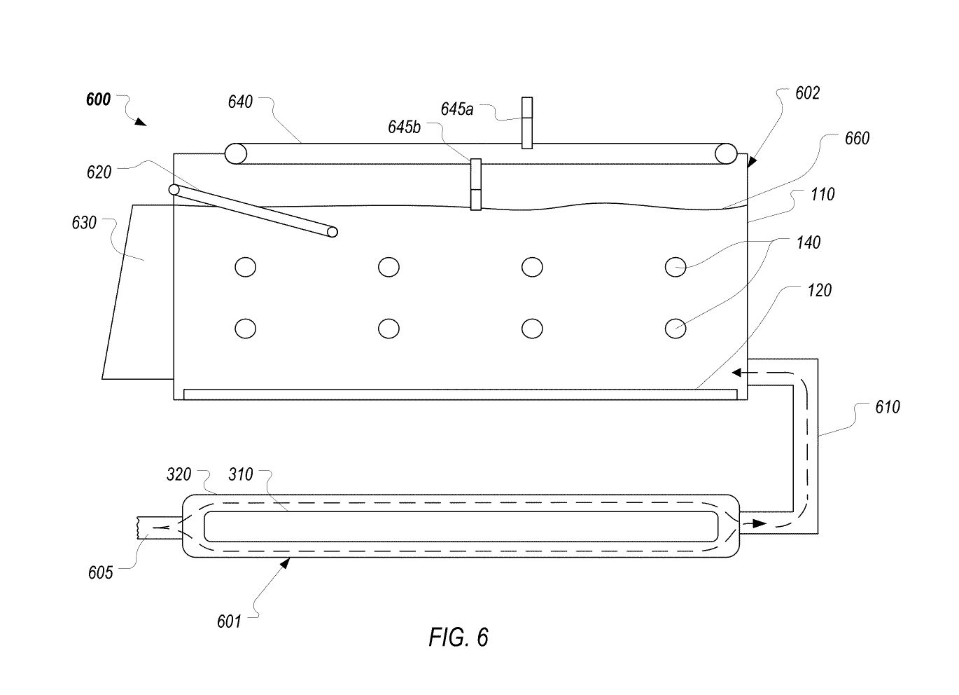

FIG. 6 illustrates embodiments of an example configuration of an apparatus 600 that treats wastewater using a two-stage approach. Apparatus 600 includes two primary components: a reactor tube 300 configured as a first stage flocculation tank 601, and a second stage flotation tank 602.

Wastewater can be inputted into first stage flocculation tank 601 through influent port 605. The wastewater can be treated within the first stage flocculation tank 601 to flocculate (i.e. cause to form clumps) contaminants within first stage flocculation tank 601. This flocculation can be caused by applying a voltage differential to the electrodes as will be further described below. Once any contaminants are flocculated to a desired degree, the wastewater containing the flocculated contaminants can be fed into second stage flotation tank 602 by a flowpath 610.

The second stage flotation tank 602 can produces gas (e.g. hydrogen and oxygen) bubbles which rise through the wastewater. As the gas bubbles rise, the gas bubbles entrain the flocculated contaminants to the surface 660 of the wastewater. This process can result in a mat of flocculated contaminants forming at the surface 660 of the wastewater. Finally, the flocculated contaminants can be removed using conveyors 620 and 640 as will be further described below.

As shown in FIG. 6, in some embodiments, the flocculation tank 601 can be configured with the electrode assembly 300 and can include an outer electrode 320 configure as a cathode formed by an outer cylinder (e.g. an enclosed pipe or tube), and an inner electrode 310 configured as an anode formed by an inner cylinder (e.g. a pipe or other enclosed cylindrical shape) that is contained within the outer cylinder. Accordingly, the wastewater can flow between the outer electrode 320 and the inner electrode 310 as shown by the dashed arrows in FIG. 6. A voltage differential can be applied across to each of outer electrode 320 and inner electrode 310 to cause an electric current to pass through the wastewater. This electric current can cause contaminants in the wastewater to flocculate (i.e. to clump together). In other embodiments, the flocculation tank 601 can be configured with electrode assembly 400 configured in a flow-through configuration.

Regardless of the mode used to treat the wastewater, flocculation tank 601 can be configured with controls for automatically determining the appropriate settings to ensure that contaminants are sufficiently flocculated before exiting flocculation tank 601. For example, in a batch mode configuration, flocculation tank 601 can automatically determine an appropriate duration of time to treat the wastewater or appropriate voltage levels to apply across inner electrode 310 and outer electrode 320. Similarly, in a continuous flow mode configuration, flocculation tank 601 can automatically determine an appropriate flow rate and appropriate voltage levels to apply across inner electrode 310 and outer electrode 320.

Once the contaminants are flocculated in the wastewater, the wastewater can be transferred via flowpath 610 to flotation tank 602. An electrical field can be applied to the wastewater within flotation tank 602 using electrodes 120, 140. The electric field can increase interface potential between solvent and solute and create micron-sized bubbles of hydrogen and oxygen gas which lift the flocculated contaminants to the surface 660. The flocculated contaminants can form a mat at the surface 660 allowing for easy removal of the contaminants. In other embodiments, the flotation tank 602 can be configured with electrode assembly 400.

Flotation tank 602 can also include conveyor 620 and conveyor 640 (having rakes 645a and 645b) and which can be configured to remove flocculated contaminants from flotation tank 602 and into collector 630 as will be further described below. Other means for removing the flocculated contaminants from the surface 660 of the wastewater can also be used as known in the art.

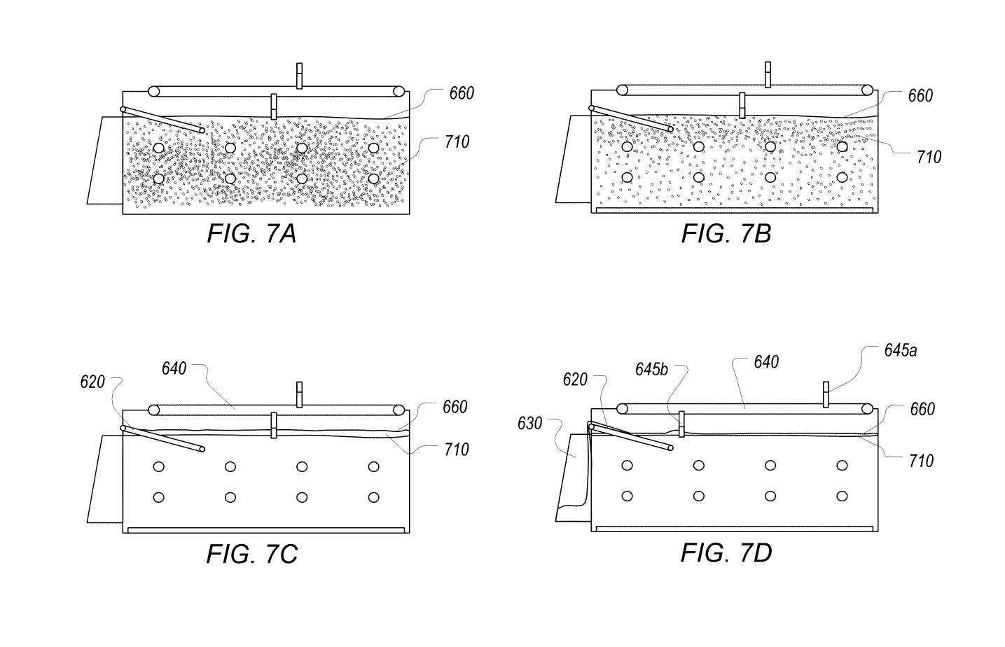

FIGS. 7A through 7D illustrate some embodiments of flotation tank 602 to provide an example of how the flocculated contaminants 710 can be floated to the surface 660 and removed. FIG. 7A illustrates the state of flotation tank 602 when wastewater containing flocculated contaminants 710 is passed into flotation tank 602. At first, the flocculated contaminants 710 can be dispersed throughout the tank 110. Next, FIG. 7B shows that as gases are generated by the electrodes, the gases rise through the wastewater and entrain the flocculated contaminants 710 to the surface 660.

FIG. 7C shows the state of flotation tank 602 after the flocculated contaminants 710 have floated to the surface 660. FIG. 7C also illustrates that the remaining wastewater underneath the floating clumps is substantially clear. Finally, FIG. 7D illustrates an example of how the flocculated contaminants 710 can be removed. As shown, this removal can be performed using rakes 645a, 645b which are rotated over the surface 660 to rake the flocculated contaminants 710 towards conveyor 620. Conveyor 620 is rotated to transfer the flocculated contaminants 710 into collector 630 where it can be retrieved for further processing or disposed.

FIGS. 7A through 7D generally represent the process as being performed in batches (i.e. the batch of wastewater is fully flocculated before any wastewater is added). However, in some embodiments, this process can be performed on a continuous basis such as by periodically adding wastewater containing flocculated contaminants 710.

Gas bubble formation can be facilitated by strategically placing the electrodes in proximity to one another. For example, in some embodiments, the cathode(s) and anode(s) are spaced between about 0.1 inches and about 36 inches apart, between about 0.2 inches and about 24 inches apart, about 0.5 inches and about 12 inches apart, about 0.5 inches and about 6 inches apart, about 3 to about 8 inches apart, about 1 inch to about 3 inches apart, or variations and combinations of these ranges or values within these ranges. The ratio of separation may vary depending on the conductivity of the wastewater and/or the power levels applied to the electrodes. For example, the more saline or conductive the wastewater, the smaller the gap that may be required for hydrogen and/or oxygen production. In some configurations, the placement of two or more cathodes near a single anode can increase turbulence about the anode, creating a heightened mixing effect that can assist in aggregating and lifting the flocculated contaminants 710.

Single Stage System for Aggregating and Removing Compounds from Wastewater

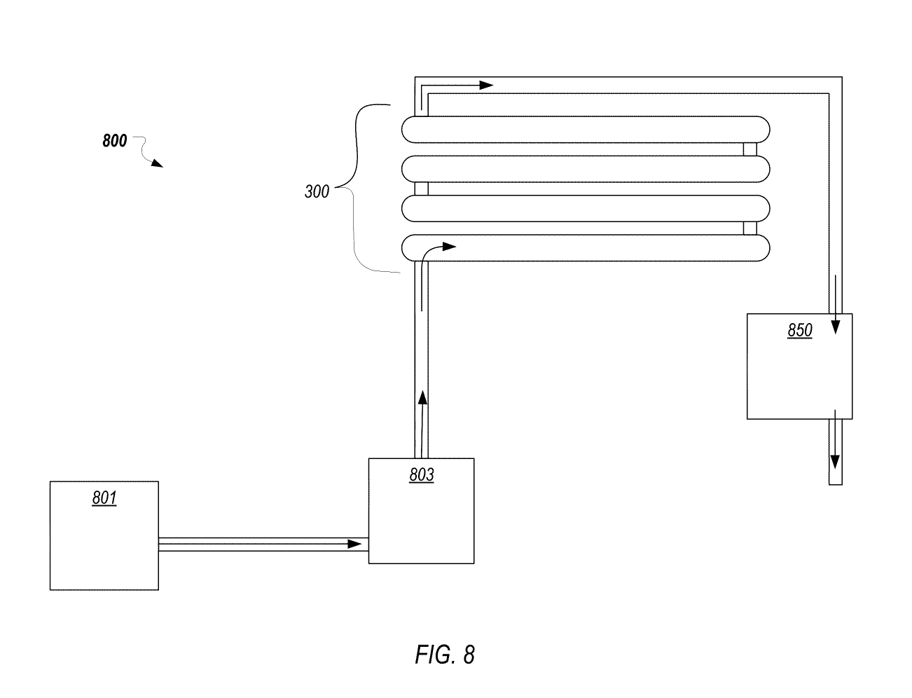

FIG. 8 illustrates embodiments of an example system 800 for aggregating and removing compounds from wastewater. System 800 can comprise a wastewater source 801 that is contaminated with compounds. The wastewater can be fed through a series of reactor tubes 300 by a pump 803. As the wastewater passes through the reactor tubes 300, a voltage differential can be applied to the reactor tubes 300 and the flow of the electrical current through the reactor tubes 300 can cause the compounds in the wastewater to aggregate. After the wastewater exits the reactor tubes 300, a strainer 850 can be used to remove the aggregate compounds from the wastewater. The wastewater can then be diverted for reuse or for further processing. In some embodiments, system 800 can comprise reactor tubes 300 configured with the electrode assembly 400. In other embodiments, the electrodes of system 800 can be configured with mixed metal oxide materials. In yet other embodiments, the electrodes of system 800 can be configured with non-donating conductive materials.

Single Stage System for Treating Wastewater with Chlorine Based Elements.

Electrochemical processing may provide a means for treating wastewater, in particular for removing ammonia from wastewater. Chlorine based elements can also be an effective means for treating wastewater. In some embodiments, chlorine based elements can treat wastewater by removing ammonia and/or by removing or reducing microorganisms. In other embodiments, electrochemical processing can be used to treat wastewater by direct oxidation of ammonia at electrode-liquid interfaces at the anode and by indirect oxidation by the formation of hydroxyl radical and HOCl to react with ammonia.

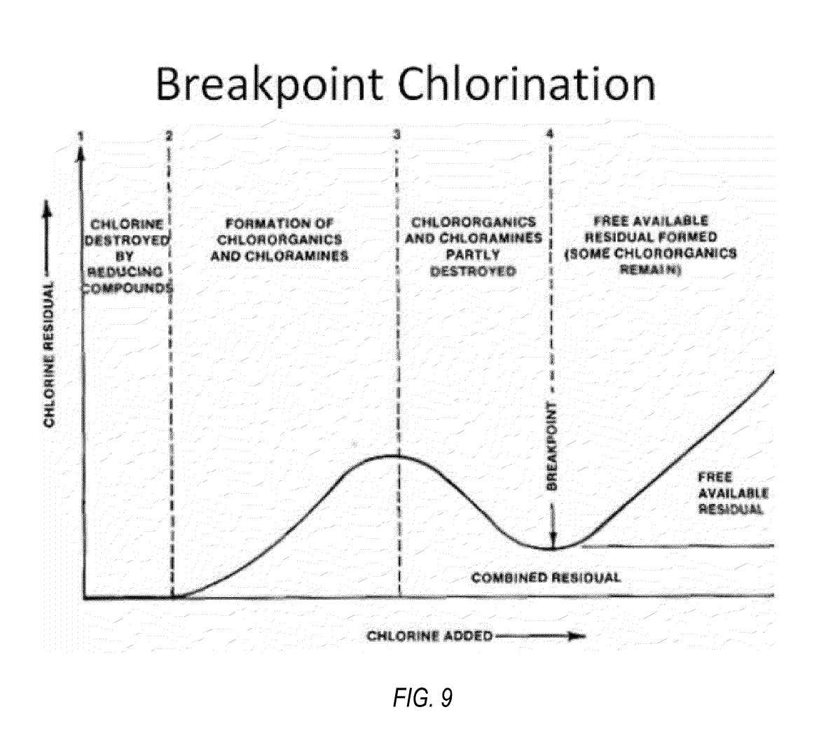

The chemical removal of ammonia compounds can be achieved in stages. This process is referred to as Breakpoint chlorination and is illustrated in FIG. 9. The graph in FIG. 9 illustrates what happens to chlorine when it is added to water (whether as a chlorine gas or a hypochlorite). When chlorine enters water, it can begin to react with compounds found in the water including reducing agents such as hydrogen sulfide and ferrous irons. These initial reactions can produce chloride ions or hydrochloric acid which may have no disinfecting properties. FIG. 9 illustrates this stage between points 1 and 2. As shown, there may be no chlorine residual during this first stage.

As more chlorine is added to the water, the chlorine can react with organics and ammonia naturally found in the water. During this second stage, illustrated as occurring between points 2 and 3, the reactions can produce chloramines and therefore the chlorine residual may increase.

In a third stage, between points 3 and 4, as more chlorine is added, the chlorine can react to break down most of the chloramines in the water that were produced during the second stage or otherwise present in the water. These reactions may consume the chlorine thereby lowering the chlorine residual in the water.

Finally, at point 4, as more chlorine is added, the water reaches the breakpoint. The breakpoint is the point at which the chlorine demand has been totally satisfied (i.e. the chlorine has reacted with all reducing agents, organics, and ammonia in the water). When more chlorine is added past the breakpoint, the chlorine reacts with water and forms hypochlorous acid in direct proportion to the amount of chlorine added resulting in an increasing amount of chlorine residual.

There are various important factors in this breakpoint chlorination process that may determine whether the process can be implemented in an efficient and satisfactory manner. These factors include: (1) the time it takes to reach the breakpoint; (2) the amount of chlorine that must be added to create an appropriate chlorine residual level; (3) the energy costs associated with the process; (4) the scalability of the process; and (5) the adaptability of the process to different types of water (e.g. fresh, city, brine, sea, and frac water).

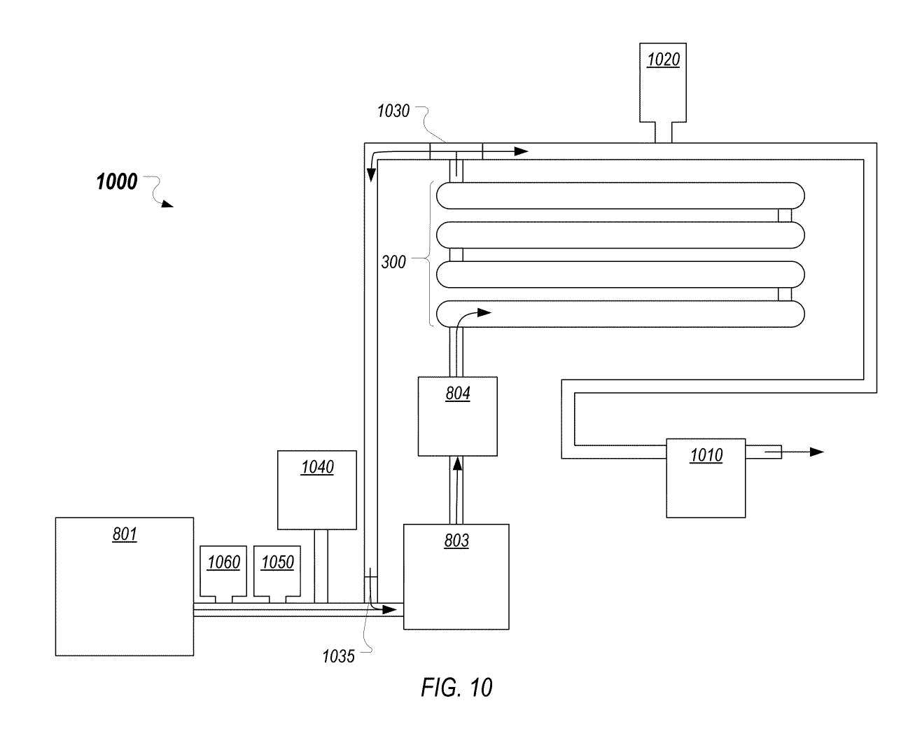

FIG. 10 illustrates embodiments of an example system 1000 for treating wastewater with chlorine based elements. System 1000 can generally be configured in a similar fashion to system 800. System 1000 can include a wastewater source 801. Wastewater source 801 can be any source of wastewater including ponds, streams, industrial plants, fish farms or suppliers or other types of wastewater. The wastewater can be fed into an impeller pump 803 which pumps the wastewater into a mixing area 804 and then through a series of reactor tubes 300. Although four reactor tubes are shown in system 1000, other numbers of reactor tubes 300 can be used to accomplish a desired level of water treatment.

If the wastewater does not have a sufficient level of chlorine, a hypochlorite source 1040 can supply hypochlorite (ClO⁻) to the wastewater stream prior to impeller pump 803. Although hypochlorite is primarily described as the source of chlorine that can be supplied to unprocessed water, other chlorine sources (or chlorine based elements) can also be used Impeller pump 803 can naturally cause cavitation in the wastewater which creates numerous micron bubbles containing hypochlorite. The mixing of these micron bubbles in the wastewater can be increased within mixing area 804. Mixing area 804 may be any portion of the path between impeller pump 803 and the reactor tubes 300. For example, mixing area 804 can be a tank or other container positioned inline between the two components or can simply be a length of the pipe connecting the two components. This mixing of the micron bubbles can increase the rate of interaction of the hypochlorite and the ammonia as well as the rate of interaction of the hypochlorite and other chlorine based elements with the anodes.

In some embodiments, the micron bubbles can be between about one hundred microns to about five hundred microns in diameter. In other embodiments, the micron bubbles can have low rising velocity and high inner pressure. In yet other embodiments, wastewater treatment by system 1000 can be carried out at high pressures. In some embodiments, the influent wastewater can be placed under high pressure beginning with input and continuing until discharge from the reactor tubes 300. In some embodiments, upon discharge from the high pressure environment of the reactor tubes 300 to a low pressure environment, the pressure differential can cause rise of micron bubbles and can improve reaction with chlorine based elements, flocculation of contaminants, and/or suspension of dissolved solids. In other embodiments, the pressure differential can cause implosion of hydrodynamic cavitation of the micron bubbles and can improve reaction with chlorine based elements, flocculation, and/or suspension of dissolved solids. In yet other embodiments, the output of system 1000 can be further processed by a second stage flotation tank 602 which can be configured to remove flocculated contaminants and/or suspended solids entrained to the surface by the micron bubbles.

In some embodiments, the reactor tube anode can be comprised of a titanium core with a MMO coating. When a voltage is applied to the MMO anode in the presence of ammonia and other chlorine based elements, hypochlorite can be produced. Accordingly, the combination of the production of hypochlorite via electrolysis and the increased interaction due to the mixing of the micron bubbles in the wastewater speeds the breakpoint chlorination process depicted in FIG. 9. In other words, the time required to pass from point 1 to point 4 in FIG. 9 is increased by producing more chlorine residual (i.e. hypochlorite) and by increasing the rate of interaction of this chlorine residual with the ammonia.

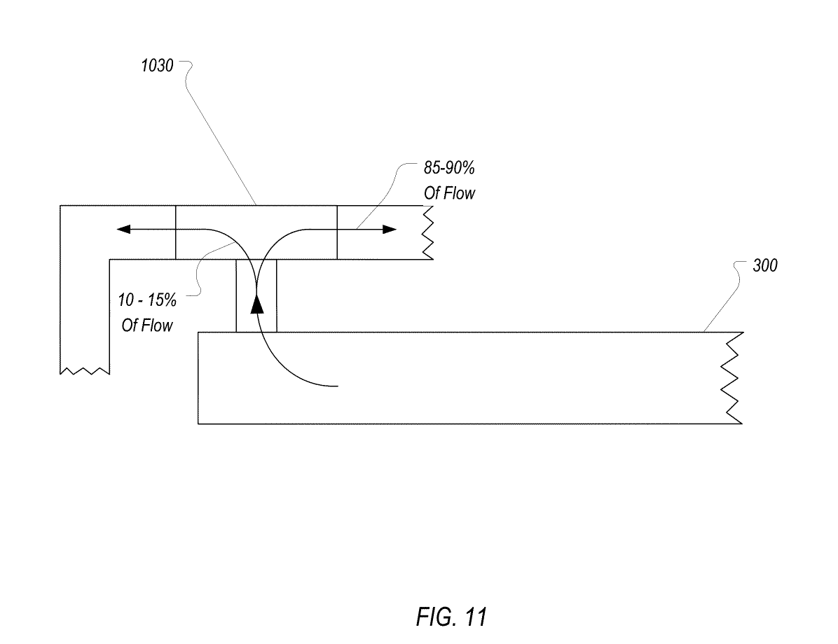

FIG. 10 also shows that system 1000 includes a feedback loop comprised of a flow-splitting valve 1030 and a one-way valve 1035. Flow-splitting valve 1030 causes a portion of the processed wastewater to be returned back to the input to impeller pump 803. In some embodiments, this portion can be 10-15% of the wastewater as shown in FIG. 11. In other embodiments, the portion of wastewater returned can be at least 30%. However, any desired amount can be diverted back through the feedback loop. One-way valve 1035 can prevent the unprocessed wastewater from flowing back into the feedback loop.

Because the treated wastewater contains an amount of residual hypochlorite (e.g. as shown by the rising curve after point 4 in FIG. 9), a portion of the treated wastewater can be returned to act as an additional source of hypochlorite. In this way, the amount of hypochlorite available within the wastewater passing through reactor tubes 300 can be increased without requiring the additional input of hypochlorite (e.g. via hypochlorite source 1040). In other words, by returning a portion of the processed wastewater through the feedback path, the amount of hypochlorite can be gradually increased to further increase the speed at which the ammonia is removed.

In some embodiments of the invention, the wastewater treatment process can be automated by monitoring the oxidation reduction potential (ORP) of the treated wastewater. FIG. 10 illustrates an ORP meter 1020 for monitoring the ORP of the wastewater after the wastewater passes through the series of reactor tubes 300. It has been determined that when breakpoint chlorination occurs, the ORP of the wastewater is around 750 mV. By using the ORP metric, a system can be tuned to process wastewater at a desired rate. For example, the ORP of the wastewater can be measured prior to testing (e.g. using an ORP meter (not shown)) positioned upstream from the series of reactor tubes 300 such as in wastewater source 801 to identify a relative amount of ammonia in the wastewater. Based on this initial ORP and a desired time for eliminating the ammonia from the wastewater, it can be determined how much hypochlorite (or other chlorine based element) must be added to the wastewater (e.g. via hypochlorite source 1040) to achieve ammonia elimination in the desired time.

Similarly, ORP readings can be taken during processing to determine if the rate at which hypochlorite is added should be adjusted. For example, it can be determined from the ORP reading whether too much hypochlorite is being added (e.g. when the processed wastewater contains an excess amount of hypochlorite), and if so, the rate at which hypochlorite is being added can be reduced to conserve hypochlorite and/or to minimize the amount of free hypochlorite in the treated wastewater. Similarly adjustments could be made to increase the amount of hypochlorite added (e.g. when the ORP reading of the processed wastewater is below 750 mV).

As also shown in FIG. 10, in some embodiments, one or more post-processing filters 1010 can be included to remove the chlorine (e.g. hypochlorite) or other remaining contaminants from the treated wastewater. Filters 1010 can include activated carbon filters, clay filters, or mineral filters such as Zeolite or Diatomaceous earth filters. For example, in some embodiments, one or more granular activated carbon (GAC) filters and/or one or more copper-zinc based filters can be used.

In some embodiments, system 1000 can be configured such that the output of the system is fed back into the wastewater source. As such, system 1000 can represent using embodiments of the system to decontaminate a wastewater source such as a lake, pond, or other body of water. In other embodiments, system 1000 can be configured with the reactor tubes configured with electrode assemblies 400. In yet other embodiments, system 1000 can comprise electrodes comprised of non-donating conductive materials. In some embodiments system 1000 can be configured to as part of a system further comprising system 600 and/or system 800.

In some embodiments, the above described system 1000 can also be used with a chloride salt solution in place of hypochlorite. In some embodiments, a chloride salt solution can be mixed with the influent wastewater and then flowed through the reactor tubes. In the reactor tubes, electro-oxidation of the chloride salt generates chlorine based elements such as chlorine dioxide. To use the system with a chloride salt solution in place of hypochlorite, a chloride salt solution can be added to the wastewater in place of the hypochlorite.

FIG. 10 illustrates an injector 1050 configured to inject chloride salt into the influent wastewater stream. In some embodiments, the injector 1050 can comprise a dosing pump configured to inject a chloride salt solution into the influent wastewater stream. In other embodiments, a sodium chloride solution can be injected into the influent wastewater stream. In alternate embodiments, the system 1000 can include a monitor 1060 configured to determine the chloride salt concentration of the influent wastewater. The monitor 1060 can determine if the chloride salt concentration of the influent wastewater is sufficient for the generation of chlorine based elements such as chlorine dioxide. If the chloride salt concentration is insufficient, the monitor 1060 can activate the injector 1050 to inject chloride salt into the influent wastewater stream to increase the chloride salt concentration. If the chloride salt concentration is sufficient, no additional chloride salt is injected into the influent wastewater stream. Any added chloride salt can further mix with the influent wastewater stream in the impeller pump 803 and mixing area 804. The influent wastewater stream with chloride salt enters the reactor tubes 300 where electro-oxidation generates chlorine based elements such as chlorine dioxide.

In some embodiments, chloride salt can include any compound comprising chloride ions. In other embodiments, chloride salt can include any compound comprising chloride ions that is soluble in water. In yet other embodiments, chloride salt can include any compound comprising chloride ions and any ion from group 1 or group 2 of the periodic table. In some embodiments, chloride salts comprise lithium chloride, sodium chloride, potassium chloride, magnesium chloride, calcium chloride, or combinations thereof.

In some embodiments, a chloride salt can be added to the wastewater source to raise the level of chloride salt to about 0.9 g/l. The injector 1050 can be configured as a dosing pump to inject a chloride salt solution of about 120 g/l into the influent wastewater stream. In other embodiments, the injector 1050 can comprise a venturi.

In other embodiments, the monitor 1060 can be configured to determine the salinity of the influent wastewater. In alternate embodiments, the monitor 1060 can be configured to determine the conductivity of the influent wastewater stream.

In another embodiment, the system 1000 can further comprise sensors to monitor and/or adjust temperature, pressure, ammonia concentration, chlorine dioxide concentration, pH, dissolved oxygen, dissolved gases, dissolved solids, turbidity, COD, BOD and/or conductivity.

Single Stage System for Treating Wastewater

In some embodiments, the present application further discloses a system for treating wastewater by generating hydrogen gas and halides with electrode assemblies. A voltage can be applied to the electrodes to generate hydrogen gas to remove suspended solids from wastewater and to disinfect wastewater. The electrode assemblies may be configured into arrays by fixing a plurality of electrodes into a nonconductive frame. The array of electrode assemblies can be positioned within the wastewater for optimal effect or multiple arrays of electrode assemblies can be positioned within the wastewater for optimal effect. In other embodiments the electrode arrays can be configured to operate in a flow-through configuration. In other embodiments, the decay of the electrodes can be avoided by the use of non-donating electrodes thereby reducing the need to replace electrodes and the need to remove decayed metal ions from the wastewater.

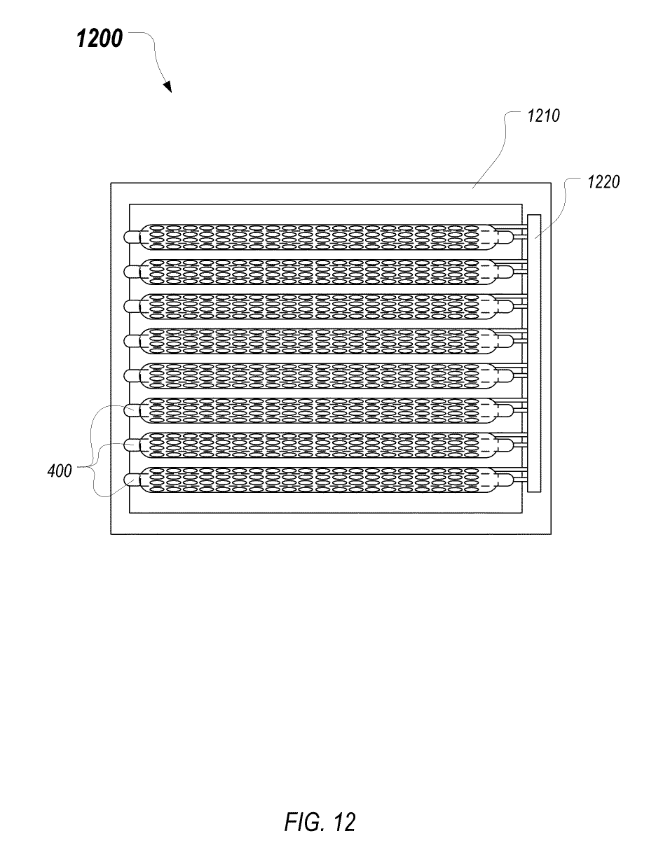

FIG. 12 illustrates an example electrode array 1200 comprising a nonconductive frame 1210 configured to secure a plurality of electrode assemblies 400. The electrode array 1200 further comprises a connector system 1220 configured to connect the inner electrode connectors 415 and the outer electrode connectors 425 of the plurality of electrode assemblies 400. The connector system 1220 is configured to electrically connect the plurality of electrode assemblies 400 in parallel. In some embodiments, the nonconductive frame 1210 is configured to secure the plurality of electrode assemblies 400 in a planar configuration. In other embodiments, the nonconductive frame 1210 is configured to secure the plurality of electrode assemblies 400 in other configurations that minimize dead zones and maximize release of gas. In alternate embodiments, the nonconductive frame 1210 can comprise other suitable nonconductive materials such as plastic, epoxy, fiberglass, glass, ceramics and rubber. In another embodiment, the connector system 1220 is configured to electrically connect the plurality of electrode assemblies 400 in series. In yet another embodiment, the electrode array 1200 is configured such that individual electrode assemblies 400 can be easily removed and replaced within the electrode array 1200.

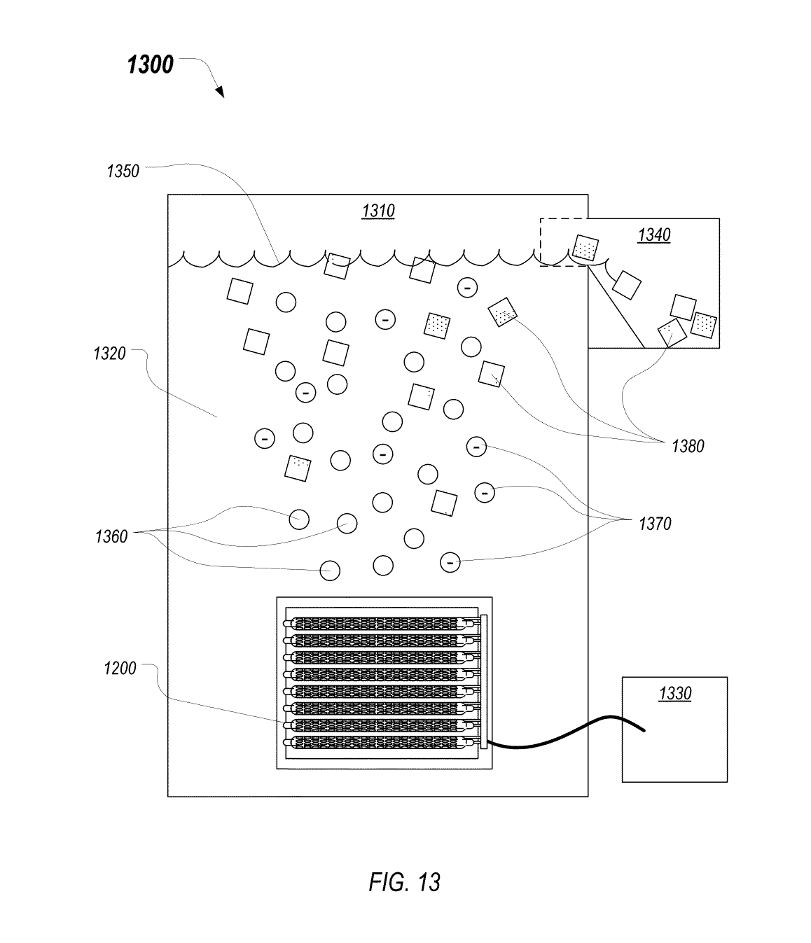

FIG. 13 illustrates embodiments of an example system 1300 for removal of suspended solids and disinfection of water. The system 1300 can comprise a vessel 1310, one or more electrode arrays 1200, an aqueous medium 1320, a power supply 1330, and a precipitate removal system 1340. The vessel 1310 can be configured to contain the wastewater 1320. In some embodiments, the vessel 1310 can also be electrically insulated from the surrounding environment. The one or more electrode arrays 1200 can be immersed in the wastewater 1320 and can be secured on the side or bottom of the vessel 1310. The wastewater 1320 can comprise water with suspended solids and bacteria and other microorganisms. The electrode array 1200 can be electrically connected to the power supply 1330. The precipitate removal system 1340 can be configured to work as a protein skimmer to remove floating precipitated solids from the surface of the aqueous medium 1350. In this example the precipitate removal system 1340 is configured to attach to the side of the vessel 1310 and to be flush with the surface of the wastewater 1350.

The system 1300 can be employed by electrically energizing the array of electrodes 1200 with the power supply 1330 to activate electrolysis. As electrolysis is activated the electrode arrays 1200 can interact with the wastewater 1320 to produce hydrogen gas 1360 and halides 1370. As the hydrogen gas 1360 rises through the aqueous medium 1320 the suspended solids can be converted into precipitated solids 1380 and can be entrained to the surface 1350. The precipitated solids 1380 on the surface 1350 can then be removed by the precipitate removal system 1340. The produced halides 1370 can disperse throughout the wastewater 1320 to disinfect the wastewater 1320 of any bacteria or microorganisms. Electrolysis can continue until satisfactory removal of total suspended solids and satisfactory disinfection of the wastewater 1320 has occurred. The resulting treated wastewater 1320 can then be removed. The one or more electrode arrays 1200 of the system 1300 can be configured to allow for easy removal and/or replacement of individual electrode arrays 1200 or easy removal and/or replacement of individual electrodes 100.

In some embodiments, the wastewater 1320 can be produced water from petroleum mining, natural gas mining operations, or hydraulic fracturing operations. In other embodiments, the wastewater 1320 can be growth medium from algae growing operations. In yet other embodiments, salts, ions, or other additives can be added to the wastewater 1320 prior to electrolysis. In alternate embodiments, salts, ions, or other additives can be added to the wastewater 1320 prior to electrolysis to adjust the conductivity of the wastewater 1320.

In some embodiments, the precipitate removal system 1340 can comprise a protein skimmer equipped with a belt or rake system. In other embodiments, the belt or rake system can comprise one or more scrapers that remove precipitated solids from the belt or rake. In other embodiments, the precipitate removal system 1340 can comprise a plurality of protein skimmers.

In other embodiments, the system 1300 can be configured as a monolithic unit with a single vessel 1310 with the other accompanying system components. In some embodiments, the system 1300 can be configured to operate in a continuous flow fashion with wastewater 1320 entering the system and treated wastewater exiting the system 1300. In yet other embodiments, the system 1300 can be configured with two or more vessels 1310 and accompanying system components. Wastewater 1320 can enter the first vessel 410 and receives preliminary treatment and removal of suspended solids and disinfection of bacteria and other microorganisms. The treated aqueous medium 420 can then pass to the remaining vessels 410 for further treatment to remove remaining suspended solids and disinfection of bacteria and other microorganisms. In yet other embodiments, system 400 further comprises additional pumps, impellers, propellers and/or other liquid moving devices to satisfactorily circulate the wastewater 1320, transfer the wastewater 1320, and/or disperse the produced hydrogen gas 1360 and produced halides 1370.

In yet other embodiments, the system 1300 can be configured as a portable modular unit that can be inserted into and used in pre-existing vessels 1310. For example, such portable modular systems 1300 can be used in place of or in conjunction with conventional water treatment systems such as gun barrel systems, microbubble systems, and dissolved air flotation systems. Other portable systems 1300 can be used as part of a larger water treatment system. Other portable modular systems 1300 can be configured such that the system 1300 can move throughout the larger vessel 1310 or be set at various locations and/or depths within the vessel 1310. Other portable modular systems 1300 can be configured such that more than one of the systems 1300 can be used in a single vessel 1310.

In some embodiments the power supply 1330 provides direct current. In other embodiments the power supply 1330 is configured to vary the voltage, amperage, and current to vary the amount and efficiency of electrolysis. The voltage, amperage, and current can be varied in accordance with the electrode materials, conductivity of the wastewater 1320, composition of the wastewater 1320, size of the vessel 1310, and desired level of removal of suspended solids and disinfection of bacteria and other microorganisms.

In other embodiments, the temperature, pressure, and/or pH of the wastewater 1320 is varied to achieve the desired level of removal of suspended solids and disinfection of bacteria and other microorganisms. In another embodiment, the system 1300 further comprises sensors to monitor and/or adjust temperature, pressure, pH, dissolved oxygen, dissolved gases, dissolved solids, and/or conductivity.

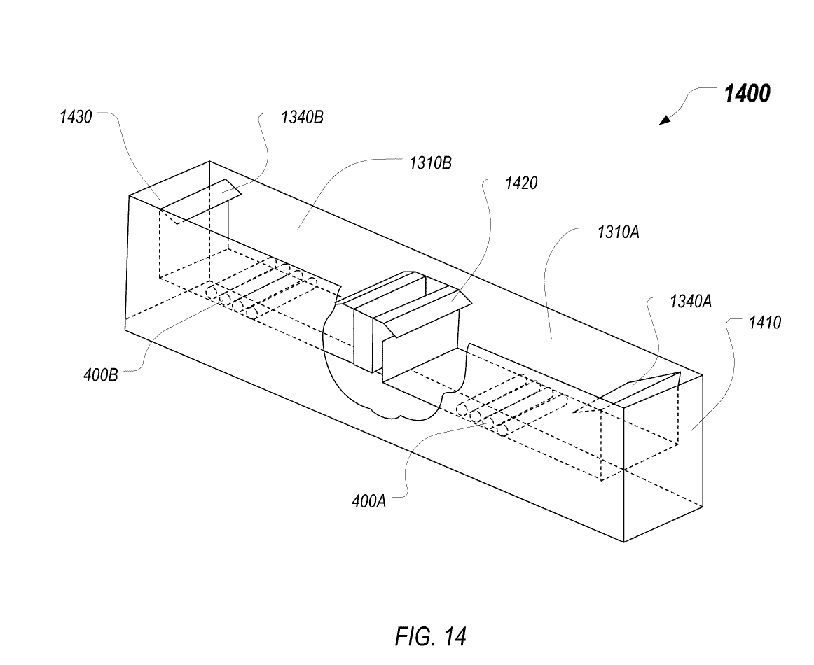

FIG. 14 illustrates embodiments of a system 1400 for treating wastewater by removal of suspended solids and disinfection. The system 1400 can comprise a double tank configuration with wastewater 1320 entering a first vessel 1310A. A first electrode array 400A can be electrically energized, generating hydrogen gas 1360 and halides 1370. The halides 1370 can disinfect the wastewater 1320. Precipitated solids 1380 can be produced from the dissolved solids and entrained to the surface 1350. A first precipitate removal system 1340A can remove the precipitated solids 1380 and deposit the precipitated solids 1380 into a first cavity 1410. The treated wastewater 1320 can then pass via a weir 1420 to a second vessel 1310B. The electrolyzing process can be repeated with a second electrode array 400B generating hydrogen gas 1360 and halides 1370. Precipitated solids 1380 can be produced from the dissolved solids and entrained to the surface 1350. The halides 1370 can further disinfect the wastewater 1320. A second precipitate removal system 1340B can remove the precipitated solids and deposit the precipitated solids 1380 into a second cavity 1430. The doubly treated wastewater 1320 is then removed from the vessel 1310B for use or for further processing.

Systems and Methods for Wastewater

In addition to ammonia, the present methods and systems can be employed to remove other contaminants from wastewater such as antibiotics, hormones, active inorganic chemicals (e.g. via reduction chemistry), and bacteria. Such contaminants can be removed from wastewater that also contains ammonia or that does not contain ammonia using the techniques described above. As wastewater containing such contaminants passes through the systems described, the interaction of the chlorine based elements and/or the electric field with the contaminants causes them to break down into less harmful or harmless elements. Accordingly, wastewater treated using the techniques of the present invention can become more suitable for subsequent use such as for use as water for fisheries, for use as a growth medium (e.g. for algae or another useful organism), and other suitable uses.

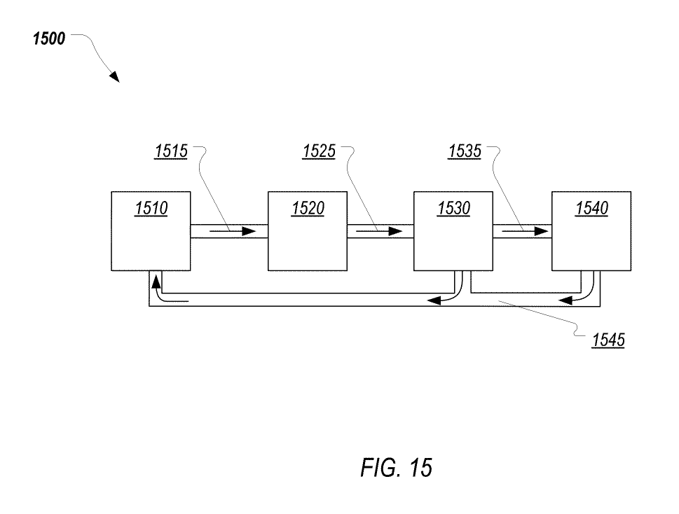

FIG. 15 illustrates an example system for treating wastewater. First, wastewater can be produced or provided 1510. Next, the wastewater can be delivered 1515 to an optional pretreatment step 1520. After the optional pretreatment step 1520, the wastewater can be delivered 1525 to an electrowater separation step 1530. Then the treated wastewater can be delivered 1535 to further treatment steps 1540. Optionally, the treated wastewater can be delivered 1545 for reuse. In some embodiments, the optional pretreatment step 1520 can include gravity separation in a holding tank, separation in a skim tank, and/or treatment in an API gunbarrel system. In yet other embodiments, the optional pretreatment step 1520 can include treatment by gravity separation, chemical means, filtration, centrifugation, and/or any other appropriate pretreatment method.

In some embodiments, the electrowater separation step 1530 can comprise any one or any combination of the systems 100, 300, 400, 600, 800, 1000, 1200, 1300, or 1400, described herein. In other embodiments, the electrowater separation step 1530 can further comprise the two stage electrocoagulation and electro-flotation process disclosed in prior application Ser. Nos. 13/942,348, 13/872,044, and 13/865,097. In alternate embodiments, the electrowater separation step 1530 can break up oil/water emulsions, remove up to 99% of dispersed oil and suspended solids, and/or kill bacteria and viruses. In yet other embodiments, the electrowater separation step 1530 can break up oil/water emulsions by neutralizing the repulsive charges of the oil droplets and suspended solids to allow them to agglomerate. In other embodiments, the electrowater separation step 1530 can remove organics by as much as 99.9% and total suspended solids by as much as 99.5%.

In other embodiments, the electrowater separation step 1530 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In other embodiments, the further treatment steps 1540 can comprise one or more additional electrowater separation steps 1530. In another embodiment, the further treatment steps 1540 can comprise any combination of filtration, microfiltration, ultrafiltration, nanofiltration, reverse osmosis treatment, and/or chemical treatment. In yet other embodiments, the further treatment steps 1540 can comprise any combination of treatment steps to generate potable water. In some embodiments, the further treatment step 1540 can comprise any one or any combination of the systems 100, 300, 400, 600, 800, 1000, 1200, 1300, or 1400, described herein. In other embodiments, the further treatment step 1540 can further comprise the two stage electrocoagulation and electro-flotation process disclosed in prior application Ser. Nos. 13/942,348, 13/872,044, and 13/865,097.

In some embodiments, the delivery steps 1515, 1525, 1535, and 1545 can be carried out by plumbing, pipes, tubing, hosing, or other fluid conveyance systems configured to deliver the wastewater. In other embodiments, the delivery steps 1515, 1525, 1535, and 1545 can further comprise storage ponds, storage reservoirs, holding tanks or storage tanks. In alternate embodiments, the delivery steps 1515, 1525, 1535, and 1545 can further comprise shipping by vehicle such as tanker truck, tanker rail car and/or tanker shipping.

Treating Wastewater from Hydraulic Fracturing

In some embodiments, the wastewater can be produced from hydraulic fracturing operations. In other embodiments, the wastewater produced from the hydraulic fracturing operation 1510 can include produced water, flowback water, and/or impounded water. In yet other embodiments, the waste water from hydraulic fracturing operations can further comprise oil/water emulsions, bacteria, and/or other contaminants. In some embodiments, the wastewater from oil and gas drilling operations can comprise hydrogen sulfide and/or hydrogen sulfide derived contaminants.

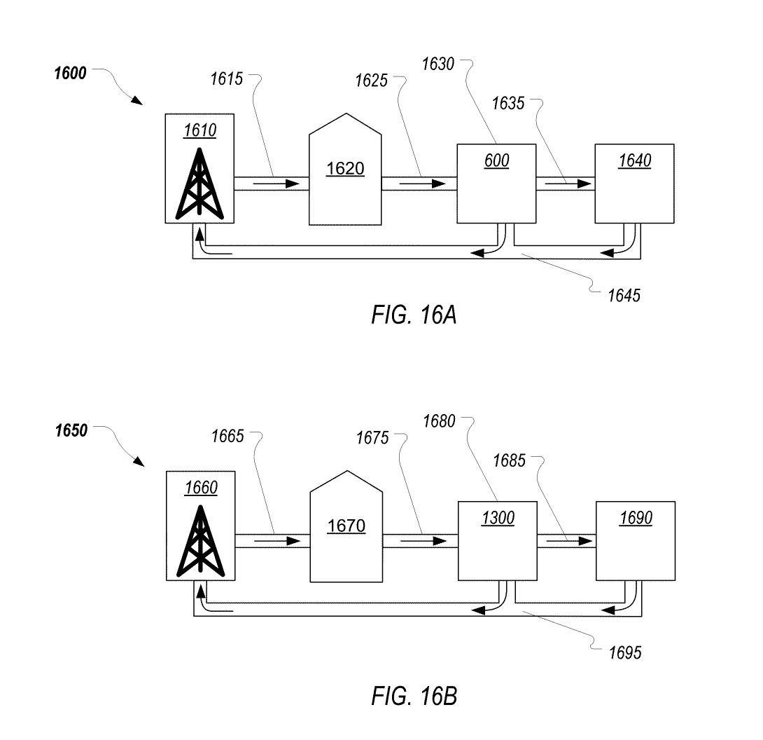

FIGS. 16A and 16B show some embodiments of systems for treating wastewater produced from hydraulic fracturing operations. FIG. 16A shows some embodiments of a system 1600 for treating wastewater produced from hydraulic fracturing operations using a two-stage flocculation and flotation system for treating wastewater. In some embodiments, system 600 can be used as a two-stage flocculation and flotation system for treating wastewater from hydraulic fracturing. First, wastewater can be produced or provided from a hydraulic fracturing operation 1610. Next, the wastewater can be delivered 1615 to an optional pretreatment step 1620. After the optional pretreatment step 1620, the wastewater can be delivered 1625 to an electrowater separation step 1630. Then the treated wastewater can be delivered 1635 to further treatment steps 1640. In some embodiments, the treated wastewater can be delivered 1645 for reuse.

In other embodiments, the optional pretreatment step 1620 can include pretreatment of the wastewater produced 1610 from hydraulic fracturing to remove hydrocarbons. In some embodiments, this optional pretreatment step 1620 to remove hydrocarbons can include gravity separation in a holding tank, separation in a skim tank, and/or treatment in an API gunbarrel system. The gas phase hydrocarbons can be removed from the top of the gravity separation tank (e.g. API gunbarrel system) and captured for further processing or use. The liquid phase hydrocarbons can be removed from the middle portion of the gravity separation tank (e.g. API gunbarrel system) and retained for further processing or use. The lower aqueous layer can be removed from the bottom of the gravity separation tank (e.g. API gunbarrel system) and be transferred to be treated by electrowater separation step 1630. In yet other embodiments, the optional pretreatment step 1620 can include treatment by gravity separation, chemical means, filtration, centrifugation, and/or any other appropriate pretreatment method. In other embodiments, the optional pretreatment step 1620 can be omitted.

In some embodiments, the electrowater separation step 1630 can comprise any one or any combination of the systems 100, 300, 400, 600, 800, 1000, 1200, 1300, or 1400, described herein. In other embodiments, the electrowater separation step 1630 can further comprise the two stage electrocoagulation and electro-flotation process disclosed in prior application Ser. Nos. 13/942,348, 13/872,044, and 13/865,097. In alternate embodiments, the electrowater separation step 1630 can break up oil/water emulsions, remove up to 99% of dispersed oil and suspended solids, and/or kill bacteria and viruses. In yet other embodiments, the electrowater separation step 1630 can break up oil/water emulsions by neutralizing the repulsive charges of the oil droplets and suspended solids to allow them to agglomerate. In other embodiments, the electrowater separation step 1630 can remove organics by as much as 99.9% and total suspended solids by as much as 99.5%.

In other embodiments, the electrowater separation step 1630 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In some embodiments, the electrowater separation step 1630 can comprise system 600 configured as a two-stage flocculation and flotation system for treating wastewater from hydraulic fracturing. The wastewater produced from hydraulic fracturing 1610 can be transferred directly to electrowater separation step 1630 configured as system 600. In the first flocculation tank 601, a voltage can be applied to the reactor tubes 300 causing suspended hydrocarbons and other contaminants in the wastewater to agglomerate. Next, the wastewater can be transferred to the second tank 602 where generated gas bubbles can entrain the agglomerated hydrocarbons and other contaminants to the surface 660. The agglomerated hydrocarbons and other contaminants at the surface 660 can then be removed by conveyor belts 620, 640. The agglomerated hydrocarbons and other contaminants can then be recovered for further treatment or refining.

In other embodiments, the further treatment steps 1640 can comprise one or more additional electrowater separation steps 1630. In another embodiment, the further treatment steps 1640 can comprise any combination of filtration, microfiltration, ultrafiltration, nanofiltration, reverse osmosis treatment, and/or chemical treatment. In yet other embodiments, the further treatment steps 1640 can comprise any combination of treatment steps to generate potable water.

In some embodiments, the delivery steps 1615, 1625, 1635, and 1645 can be carried out by plumbing, pipes, tubing, hosing, or other fluid conveyance systems configured to deliver the wastewater. In other embodiments, the delivery steps 1615, 1625, 1635, and 1645 can further comprise storage ponds, storage reservoirs, holding tanks or storage tanks. In alternate embodiments, the delivery steps 1615, 1625, 1635, and 1645 can further comprise shipping by vehicle such as tanker truck, tanker rail car and/or tanker shipping.

FIG. 16B shows some embodiments of a system 1650 for treating wastewater produced from hydraulic fracturing operations using a single stage system for treating wastewater. In some embodiments, system 1300 can be used as a single-stage system for treating wastewater from hydraulic fracturing. First, wastewater can be produced or provided from a hydraulic fracturing operation 1660. Next, the wastewater can be delivered 1665 to an optional pretreatment step 1670. After the optional pretreatment step 1670, the wastewater can be delivered 1675 to an electrowater separation step 1680. Then the treated wastewater can be delivered 1685 to further treatment steps 1690. In some embodiments, the treated wastewater can be delivered 1695 for reuse.

In other embodiments, the optional pretreatment step 1670 can include pretreatment of the wastewater produced 1660 from hydraulic fracturing to remove hydrocarbons. In some embodiments, this optional pretreatment step 1670 to remove hydrocarbons can include gravity separation in a holding tank, separation in a skim tank, and/or treatment in an API gunbarrel system. The gas phase hydrocarbons can be removed from the top of the gravity separation tank (e.g. API gunbarrel system) and captured for further processing or use. The liquid phase hydrocarbons can be removed from the middle portion of the gravity separation tank (e.g. API gunbarrel system) and retained for further processing or use. The lower aqueous layer can be removed from the bottom of the gravity separation tank (e.g. API gunbarrel system) and be transferred to be treated by electrowater separation step 1680. In yet other embodiments, the optional pretreatment step 1670 can include treatment by gravity separation, chemical means, filtration, centrifugation, and/or any other appropriate pretreatment method. In other embodiments, the optional pretreatment step 1670 can be omitted.

In some embodiments, the electrowater separation step 1680 can comprise any one or any combination of the systems 100, 300, 400, 600, 800, 1000, 1200, 1300, or 1400, described herein. In other embodiments, the electrowater separation step 1680 can further comprise the two stage electrocoagulation and electro-flotation process disclosed in prior application Ser. Nos. 13/942,348, 13/872,044, and 13/865,097. In alternate embodiments, the electrowater separation step 1680 can break up oil/water emulsions, remove up to 99% of dispersed oil and suspended solids, and/or kill bacteria and viruses. In yet other embodiments, the electrowater separation step 1680 can break up oil/water emulsions by neutralizing the repulsive charges of the oil droplets and suspended solids to allow them to agglomerate. In other embodiments, the electrowater separation step 1680 can remove organics by as much as 99.9% and total suspended solids by as much as 99.5%.

In other embodiments, the electrowater separation step 1680 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In some embodiments, the electrowater separation step 1680 can comprise system 1300 configured as a single-stage system for treating wastewater from hydraulic fracturing. The wastewater produced from hydraulic fracturing 1660 can be transferred directly to electrowater separation step 1680 configured with a system 1300. In the vessel 1310, a voltage can be applied to the electrode array generating gas bubbles 1360. Hydrocarbons and precipitated solids 1380 can then be entrained to the surface 1350 and removed by the precipitate removal system 1340. Produced halides 1370 can disperse throughout the wastewater 1320 to disinfect the wastewater 1320. In other embodiments, the electrowater separation step 1680 can be configured as part of a gravity separation step such as an API gunbarrel system.

In other embodiments, the further treatment steps 1690 can comprise one or more additional electrowater separation steps 1680. In another embodiment, the further treatment steps 1690 can comprise any combination of filtration, microfiltration, ultrafiltration, nanofiltration, reverse osmosis treatment, and/or chemical treatment. In yet other embodiments, the further treatment steps 1690 can comprise any combination of treatment steps to generate potable water.

In some embodiments, the delivery steps 1665, 1675, 1685, and 1695 can be carried out by plumbing, pipes, tubing, hosing, or other fluid conveyance systems configured to deliver the wastewater. In other embodiments, the delivery steps 1665, 1675, 1685, and 1695 can further comprise storage ponds, storage reservoirs, holding tanks or storage tanks. In alternate embodiments, the delivery steps 1665, 1675, 1685, and 1695 can further comprise shipping by vehicle such as tanker truck, tanker rail car and/or tanker shipping

In some embodiments, electrowater separation steps 1630 and 1680 can further comprise system 1000 to treat hydrogen sulfide and/or hydrogen sulfide derived contaminants in the wastewater produced from hydraulic fracturing. System 1000 can be configured to generate chlorine based elements that mitigate or remove hydrogen sulfide and/or hydrogen sulfide derived contaminants in the wastewater produced from hydraulic fracturing. In some embodiments, the systems 1600 and 1650 configured with system 1000 can be configured to treat hydrogen sulfide and/or hydrogen sulfide derived contaminants in the produced water, in the “cut” (portion of the produced water that contains the oil recovered from the formation), and/or in the recovered crude oil.

Treating Wastewater from Oil and Gas Operations

In some embodiments, the wastewater can be produced water from oil and gas drilling operations. The produced water may be a byproduct produced along with oil and gas. In alternate embodiments, the produced water may be from waterflooding to increase oil production. In other embodiments, the produced water can be highly contaminated with hydrocarbons and drilling chemicals. In yet other embodiments, the waste water from oil and gas drilling operations can further comprise oil/water emulsions, bacteria, and/or other contaminants. In further embodiments, the wastewater can be from enhanced oil recovery systems. In some embodiments, the wastewater from oil and gas drilling operations can comprise hydrogen sulfide and/or hydrogen sulfide derived contaminants.

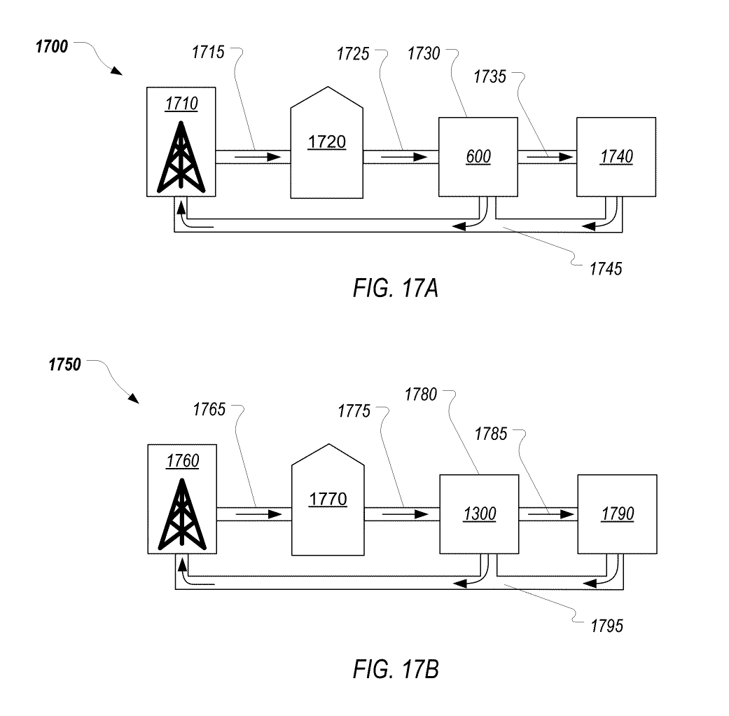

FIGS. 17A and 17B show some embodiments of systems for treating wastewater produced from oil and gas drilling operations. FIG. 17A shows some embodiments of a system 1700 for treating wastewater produced from oil and gas operations using a two-stage flocculation and flotation system for treating wastewater. In some embodiments, system 600 can be used as a two-stage flocculation and flotation system for treating wastewater from oil and gas operations. First, wastewater can be produced or provided from an oil and/or gas operation 1710. Next, the wastewater can be delivered 1715 to an optional pretreatment step 1720. After the optional pretreatment step 1720, the wastewater can be delivered 1725 to an electrowater separation step 1730. Then the treated wastewater can be delivered 1735 to further treatment steps 1740. In some embodiments, the treated wastewater can be delivered 1745 for reuse.

In other embodiments, the optional pretreatment step 1720 can include pretreatment of the wastewater produced 1710 from oil and/or gas operations to remove hydrocarbons. In some embodiments, this optional pretreatment step 1720 to remove hydrocarbons can include gravity separation in a holding tank, separation in a skim tank, and/or treatment in an API gunbarrel system. The gas phase hydrocarbons can be removed from the top of the gravity separation tank (e.g. API gunbarrel system) and captured for further processing or use. The liquid phase hydrocarbons can be removed from the middle portion of the gravity separation tank (e.g. API gunbarrel system) and retained for further processing or use. The lower aqueous layer can be removed from the bottom of the gravity separation tank (e.g. API gunbarrel system) and be transferred to be treated by electrowater separation step 1730. In yet other embodiments, the optional pretreatment step 1720 can include treatment by gravity separation, chemical means, filtration, centrifugation, and/or any other appropriate pretreatment method. In other embodiments, the optional pretreatment step 1720 can be omitted.

In some embodiments, the electrowater separation step 1730 can comprise any one or any combination of the systems 100, 300, 400, 600, 800, 1000, 1200, 1300, or 1400, described herein. In other embodiments, the electrowater separation step 1730 can further comprise the two stage electrocoagulation and electro-flotation process disclosed in prior application Ser. Nos. 13/942,348, 13/872,044, and 13/865,097. In alternate embodiments, the electrowater separation step 1730 can break up oil/water emulsions, remove up to 99% of dispersed oil and suspended solids, and/or kill bacteria and viruses. In yet other embodiments, the electrowater separation step 1730 can break up oil/water emulsions by neutralizing the repulsive charges of the oil droplets and suspended solids to allow them to agglomerate. In other embodiments, the electrowater separation step 1730 can remove organics by as much as 99.9% and total suspended solids by as much as 99.5%.

In other embodiments, the electrowater separation step 1730 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In some embodiments, the electrowater separation step 1730 can comprise system 600 configured as a two-stage flocculation and flotation system for treating wastewater from oil and/or gas operations. The wastewater produced from oil and/or gas operations 1710 can be transferred directly to electrowater separation step 1730 configured as system 600. In the first flocculation tank 601, a voltage can be applied to the reactor tubes 300 causing suspended hydrocarbons and other contaminants in the wastewater to agglomerate. Next, the wastewater can be transferred to the second tank 602 where generated gas bubbles can entrain the agglomerated hydrocarbons and other contaminants to the surface 660. The agglomerated hydrocarbons and other contaminants at the surface 660 can then be removed by conveyor belts 620, 640. The agglomerated hydrocarbons and other contaminants can then be recovered for further treatment or refining.

In other embodiments, the further treatment steps 1740 can comprise one or more additional electrowater separation steps 1730. In another embodiment, the further treatment steps 1740 can comprise any combination of filtration, microfiltration, ultrafiltration, nanofiltration, reverse osmosis treatment, and/or chemical treatment. In yet other embodiments, the further treatment steps 1740 can comprise any combination of treatment steps to generate potable water.

In some embodiments, the delivery steps 1715, 1725, 1735, and 1745 can be carried out by plumbing, pipes, tubing, hosing, or other fluid conveyance systems configured to deliver the wastewater. In other embodiments, the delivery steps 1715, 1725, 1735, and 1745 can further comprise storage ponds, storage reservoirs, holding tanks or storage tanks. In alternate embodiments, the delivery steps 1715, 1725, 1735, and 1745 can further comprise shipping by vehicle such as tanker truck, tanker rail car and/or tanker shipping.

FIG. 17B shows some embodiments of a system 1750 for treating wastewater produced from oil and gas operations using a single stage system for treating wastewater. In some embodiments, system 1300 can be used as a single-stage system for treating wastewater from oil and gas operations. First, wastewater can be produced or provided from an oil and gas operation 1760. Next, the wastewater can be delivered 1765 to an optional pretreatment step 1770. After the optional pretreatment step 1770, the wastewater can be delivered 1775 to an electrowater separation step 1780. Then the treated wastewater can be delivered 1785 to further treatment steps 1790. In some embodiments, the treated wastewater can be delivered 1795 for reuse.

In other embodiments, the optional pretreatment step 1770 can include pretreatment of the wastewater produced 1760 from oil and/or gas operations to remove hydrocarbons. In some embodiments, this optional pretreatment step 1770 to remove hydrocarbons can include gravity separation in a holding tank, separation in a skim tank, and/or treatment in an API gunbarrel system. The gas phase hydrocarbons can be removed from the top of the gravity separation tank (e.g. API gunbarrel system) and captured for further processing or use. The liquid phase hydrocarbons can be removed from the middle portion of the gravity separation tank (e.g. API gunbarrel system) and retained for further processing or use. The lower aqueous layer can be removed from the bottom of the gravity separation tank (e.g. API gunbarrel system) and be transferred to be treated by electrowater separation step 1780. In yet other embodiments, the optional pretreatment step 1770 can include treatment by gravity separation, chemical means, filtration, centrifugation, and/or any other appropriate pretreatment method. In other embodiments, the optional pretreatment step 1770 can be omitted.

In some embodiments, the electrowater separation step 1780 can comprise any one or any combination of the systems 100, 300, 400, 600, 800, 1000, 1200, 1300, or 1400, described herein. In other embodiments, the electrowater separation step 1780 can further comprise the two stage electrocoagulation and electro-flotation process disclosed in prior application Ser. Nos. 13/942,348, 13/872,044, and 13/865,097. In alternate embodiments, the electrowater separation step 1780 can break up oil/water emulsions, remove up to 99% of dispersed oil and suspended solids, and/or kill bacteria and viruses. In yet other embodiments, the electrowater separation step 1780 can break up oil/water emulsions by neutralizing the repulsive charges of the oil droplets and suspended solids to allow them to agglomerate. In other embodiments, the electrowater separation step 1780 can remove organics by as much as 99.9% and total suspended solids by as much as 99.5%.

In other embodiments, the electrowater separation step 1780 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In some embodiments, the electrowater separation step 1780 can comprise system 1300 configured as a single-stage system for treating wastewater from oil and/or gas operations. The wastewater produced from an oil and gas operation 1760 can be transferred directly to electrowater separation step 1780 configured with a system 1300. In the vessel 1310, a voltage can be applied to the electrode array generating gas bubbles 1360. Hydrocarbons and precipitated solids 1380 can then be entrained to the surface 1350 and removed by the precipitate removal system 1340. Produced halides 1370 can disperse throughout the wastewater 1320 to disinfect the wastewater 1320. In other embodiments, the electrowater separation step 1780 can be configured as part of a gravity separation step such as an API gunbarrel system.

In other embodiments, the further treatment steps 1790 can comprise one or more additional electrowater separation steps 1780. In another embodiment, the further treatment steps 1790 can comprise any combination of filtration, microfiltration, ultrafiltration, nanofiltration, reverse osmosis treatment, and/or chemical treatment. In yet other embodiments, the further treatment steps 1790 can comprise any combination of treatment steps to generate potable water.

In some embodiments, the delivery steps 1765, 1775, 1785, and 1795 can be carried out by plumbing, pipes, tubing, hosing, or other fluid conveyance systems configured to deliver the wastewater. In other embodiments, the delivery steps 1765, 1775, 1785, and 1795 can further comprise storage ponds, storage reservoirs, holding tanks or storage tanks. In alternate embodiments, the delivery steps 1765, 1775, 1785, and 1795 can further comprise shipping by vehicle such as tanker truck, tanker rail car and/or tanker shipping.

In some embodiments, electrowater separation steps 1730 and 1780 can further comprise system 1000 to treat hydrogen sulfide and/or hydrogen sulfide derived contaminants in the wastewater produced from oil and gas operations. System 1000 can be configured to generate chlorine based elements that mitigate or remove hydrogen sulfide and/or hydrogen sulfide derived contaminants in the wastewater produced from oil and gas operations. In some embodiments, the systems 1700 and 1750 configured with system 1000 can be configured to treat hydrogen sulfide and/or hydrogen sulfide derived contaminants in the produced water, in the “cut” (portion of the produced water that contains the oil recovered from the formation), and/or in the recovered crude oil. In other embodiments, systems 1700 and 1750 configured with system 1000 can be configured to “sweeten” crude oil or to remove sulfur and sulfur-based compounds from crude oil.

Treating Industrial Wastewater

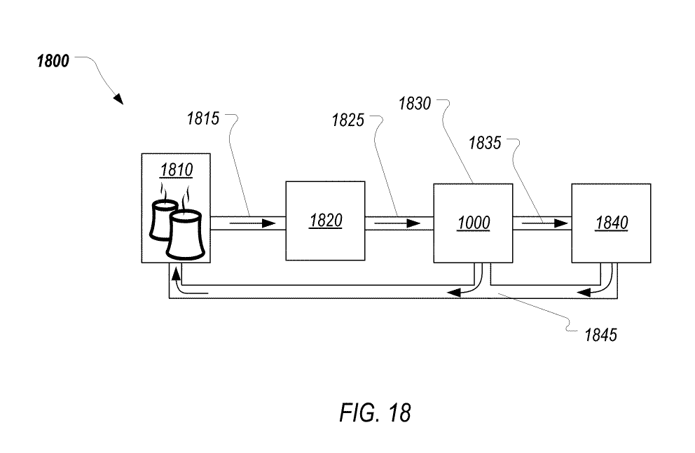

FIG. 18 shows some embodiments of systems 1800 for treating industrial wastewater. In some embodiments, the industrial wastewater can include wastewater from cooling towers, process water, and mill water. In other embodiments, the wastewater can be industrial water and the system 1800 can be configured to control odors in the industrial wastewater and to remove bacteria and other microorganisms from the industrial wastewater. In yet other embodiments, the system 1800 can be configured to control odor by removing odor-causing microorganisms and by destroying hydrogen sulfide odors through chemical oxidation by generation of chlorine dioxide. In some embodiments, the system 1800 can be configured to generate chlorine dioxide for pulp bleaching and/or to treat industrial wastewater from pulp bleaching operations. In other embodiments, the system 1800 can be configured for effective nitrification control. In some embodiments, the system 1800 can be configured for zebra mussel control.

In some embodiments, system 1800 can be configured to treat industrial wastewater from cooling loops including cooling tower operations. In other embodiments wastewater from cooling loop water can result from use of process water for re-gasification of liquefied natural gas, oil refineries, petrochemical plants, oil platforms, desalination operations, and power plants. The operation of cooling towers can lead to the buildup of microorganisms, slime, algae, and/or algae-like organisms (biological fouling or biofouling) in the resultant industrial wastewater. Control of the buildup of the resultant microorganism, algae, and/or algae-like organisms can be important for the efficient operation of the cooling loop. The buildup of resultant biofouling can lead to the formation of slime layers, colonies of microorganisms, increased deposits in the cooling system, buildup of odors, loss of heat transfer due to the insulating nature of the deposits, increased corrosion rates, and increased consumption of power due to flow restriction caused by deposits. In other embodiments, system 1800 can be configured to remedy and/or reverse biofouling or buildup of microorganisms, slime, algae, and/or algae-like organisms by introducing chlorine based elements into the cooling loop water. The introduction of chlorine based elements by system 1800 can effectively sanitize the cooling loop water and kill and/or remove slime layers, colonies of microorganisms, and/or deposits.

In some embodiments, system 1000 can be used as a single-stage system for treating wastewater with chlorine based elements. First, wastewater can be produced or provided from an industrial water process 1810. Next, the wastewater can be delivered 1815 to an optional pretreatment step 1820. After the optional pretreatment step 1820, the wastewater can be delivered 1825 to an electrowater separation step 1830. Then the treated wastewater can be delivered 1835 to further treatment steps 1840. In some embodiments, the treated wastewater can be delivered 1845 for reuse.

In yet other embodiments, the optional pretreatment step 1820 can include treatment by gravity separation, chemical means, filtration, centrifugation, and/or any other appropriate pretreatment method. In other embodiments, the optional pretreatment step 1820 can be omitted. In some embodiments, the optional pretreatment step 1820 can comprise any one or any combination of the systems 100, 300, 400, 600, 800, 1000, 1200, 1300, or 1400, described herein. In other embodiments, the optional pretreatment step 1820 can further comprise the two stage electrocoagulation and electro-flotation process disclosed in prior application Ser. Nos. 13/942,348, 13/872,044, and 13/865,097.

In some embodiments, the electrowater separation step 1830 can comprise any one or any combination of the systems 100, 300, 400, 600, 800, 1000, 1200, 1300, or 1400, described herein. In other embodiments, the electrowater separation step 1830 can further comprise the two stage electrocoagulation and electro-flotation process disclosed in prior application Ser. Nos. 13/942,348, 13/872,044, and 13/865,097. In alternate embodiments, the electrowater separation step 1830 can remove up to 99% of dispersed oil and suspended solids, and/or kill bacteria and viruses. In other embodiments, the electrowater separation step 1830 can remove organics by as much as 99.9% and total suspended solids by as much as 99.5%.

In other embodiments, the electrowater separation step 1830 can comprise any one of: deoiling to remove free and dispersed oil and grease; soluble organics removal to remove dissolved organics; disinfection to remove bacteria and other microorganisms; suspended solids removal to remove suspended particles, sand, and/or turbidity; dissolved gas removal to remove light hydrocarbon gases, carbon dioxide, hydrogen sulfide, and other gases; desalination or demineralization to remove dissolved salts, sulfates, nitrates, contaminants, scaling agents and other minerals; softening to remove excess water hardness; sodium adsorption ratio (SAR) adjustment to add calcium or magnesium ions to the treated water to adjust sodicity levels prior to use for irrigation; and/or removal of naturally occurring radioactive materials. In yet other embodiments, the electrowater separation step can remove up to 99% of suspended particles in the 10-25 μm range. In alternate embodiments, the electrowater separation step can remove up to 99% of dispersed oil in the 10-25 μm range.

In some embodiments, the electrowater separation step 1830 can comprise system 1000 configured as a single stage system for treating wastewater with chlorine based elements for treating industrial wastewater. The industrial wastewater 1810 can be transferred directly to electrowater separation step 1830 configured as system 1000.

The industrial wastewater 1810 can be fed into the impeller pump 803 that pumps the industrial wastewater into mixing area 804 and then through the series of reactor tubes 300. If the industrial wastewater does not have a sufficient level of chlorine or chloride based salts, hypochlorite source 1040 can supply hypochlorite into the industrial wastewater. In other embodiments, injector 1050 can add chloride salts. The impeller pump 803 can cause cavitation in the wastewater which can cause micron bubble to form in mixing area 804. Then the wastewater can pass into the reactor tubes 300 where the application of a voltage differential can generate chlorine based elements from the hypochlorite and/or chloride salts. An amount of the treated industrial wastewater can then be diverted back to be mixed with the influent industrial wastewater with the feedback loop as necessary. In some embodiments, the industrial wastewater treatment process can be automated by monitoring the oxidation reduction potential (ORP) of the treated wastewater to adjust hypochlorite/chloride salt addition, voltage, mixing time, voltage, flow rate, feedback path, and any parameters. In other embodiments, the treated industrial wastewater can be returned to the cooling loop for reuse.

In other embodiments, the further treatment steps 1840 can comprise one or more additional electrowater separation steps 1830. In another embodiment, the further treatment steps 1840 can comprise any combination of filtration, microfiltration, ultrafiltration, nanofiltration, reverse osmosis treatment, and/or chemical treatment. In yet other embodiments, the further treatment steps 1840 can comprise any combination of treatment steps to generate potable water.

In some embodiments, the delivery steps 1815, 1825, 1835, and 1845 can be carried out by plumbing, pipes, tubing, hosing, or other fluid conveyance systems configured to deliver the wastewater. In other embodiments, the delivery steps 1815, 1825, 1835, and 1845 can further comprise storage ponds, storage reservoirs, holding tanks or storage tanks. In alternate embodiments, the delivery steps 1815, 1825, 1835, and 1845 can further comprise shipping by vehicle such as tanker truck, tanker rail car and/or tanker shipping.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A system for treating wastewater from hydraulic fracturing operations or oil and gas drilling, the system comprising:
a reactor tube, the reactor tube comprising an outer cathode and an inner anode, the inner anode being positioned centrally within the outer cathode such that a spacing exists between an outer surface of the inner anode and an inner surface of the outer cathode;
a pump connected to an input of the reactor tube, the pump receiving wastewater and pumping wastewater into and through the reactor tube such that the wastewater flows between the inner anodes and the outer cathodes and exits through an output; and
a tank connected to the output of the reactor tube, the tank comprising a plurality of tank electrodes configured to generate gas bubbles;
wherein a voltage differential applied across the outer cathode and the inner anode causes contaminants in the wastewater to flocculate, wherein the gas bubbles entrain the flocculated contaminants to a surface of the tank.

2. The system of claim 1, wherein the reactor tube further comprises an outer cylinder forming a cathode and an inner cylinder contained within the outer cylinder, the inner cylinder comprising an anode.

3. The system of claim 1, wherein the spacing between the outer surface of the inner anode and the inner surface of the outer cathode is between about 1 mm to about 9 mm.

4. The system of claim 1, wherein the inner anode comprises a non-donating conductive material.

5. The system of claim 4, wherein the non-donating conductive material further comprises platinum, ruthenium, rhodium, palladium, osmium, iridium, titanium, carbon, conductive plastic or combinations thereof.

6. The system of claim 1, wherein the outer cathode comprises a non-donating conductive material.

7. The system of claim 6, wherein the non-donating conductive material further comprises platinum, ruthenium, rhodium, palladium, osmium, iridium, titanium, carbon, conductive plastic, or combinations thereof.

8. The system of claim 1, wherein the anode comprises a mixed metal oxide.

9. The system of claim 1, wherein the pump comprises an impeller pump configured to generate micron bubbles within the wastewater due to cavitation.

10. The system of claim 1, wherein the tank further comprises a conveyor system to remove the flocculated contaminants from the surface of the tank.

11. The system of claim 1, wherein the tank electrodes further comprise an inner electrode and an outer electrode, the inner electrode comprising a non-donating conductive material, the outer electrode configured to sheath the inner anode, and the outer electrode configured with a plurality of apertures.

12. A system for treating wastewater from hydraulic fracturing operations or oil and gas drilling, the system comprising:
an array of interconnected reactor tubes, each reactor tube comprising an outer cathode and an inner anode, the inner anode being positioned centrally within the outer cathode such that a spacing exists between an outer surface of the inner anode and an inner surface of the outer cathode, the inner anode comprising a non-donating material;
a pump connected to an input of the array, the pump receiving influent wastewater and pumping influent wastewater into and through the array of reactor tubes such that the wastewater flows between the inner anodes and the outer cathodes;
an injector connected to an input of the pump, the injector configured to add hypochlorite or chloride salts to the influent wastewater;
a power supply for supplying a voltage differential across the inner anodes and outer cathodes to generate chlorine based elements from the hypochlorite or chloride salts within the wastewater, wherein the chlorine based elements treat the wastewater;
a feedback path to divert a portion of the wastewater with chlorine based elements back to an input of the pump such that the chlorine based elements are mixed with influent wastewater to increase the level of chlorine based elements available in the influent wastewater; and
an oxidative reduction potential meter configured to measure the oxidative reduction potential of the treated wastewater, the meter configured to output a signal for controlling one or more of an amount of hypochlorite added to the influent wastewater, an amount of chloride salts added to the influent wastewater, a rate at which the pump pumps wastewater through the reactor tubes, a voltage level applied by the power supply, or an amount of wastewater that is diverted back through the feedback path.

13. The system of claim 12, further comprising a pretreatment tank to pretreat the influent wastewater from hydraulic fracturing operations by gravity separation, wherein a portion of hydrocarbons can be removed from the influent wastewater prior to treatment in the array of reactor tubes.

14. The system of claim 12, further comprising a tank connected to an output of the array of reactor tubes, the tank comprising a plurality of tank electrodes configured to generate gas bubbles, wherein the gas bubbles entrain the flocculated contaminants to a surface of the tank.

15. A method for treating industrial wastewater comprising:
providing industrial wastewater from cooling operations;
providing an array of interconnected reactor tubes, each reactor tube comprising an outer cathode and an inner anode being positioned centrally within the outer cathode such that a spacing exists between the outer surface of the anode and the inner surface of the cathode, at least one of the inner anodes comprising a non-donating conductive material;
injecting hypochlorite or chloride salts into the wastewater;
pumping wastewater with the hypochlorite or the chloride salts into and through the array such that the wastewater flows between the inner anodes and the outer cathodes;
applying a voltage differential to the anode and cathode of each reactor tube to generate chlorine based elements from the hypochlorite or the chloride salts, the chlorine based elements treating the wastewater to generate treated water; and
diverting a portion of the treated water to an input of the array such that chlorine based elements contained in the treated water are supplied into the wastewater that is pumped into the array.

16. The method of claim 15, wherein the inner anode comprises a titanium ruthenium alloy.

17. The method of claim 15, wherein the inner anode comprises a non-donating conductive material.

18. The method of claim 17, wherein the non-donating conductive material further comprises platinum, ruthenium, rhodium, palladium, osmium, iridium, titanium, carbon, conductive plastic or combinations thereof.

19. The method of claim 15, wherein pumping the wastewater further comprises pumping with an impeller pump configured to generate micron bubbles within the wastewater due to cavitation.

20. The method of claim 15, wherein the method further comprises filtration of the treated water.
